(19) United States
(12) Patent Application Publication
(10) Pub. No.: US 2014/0038305 A1
(43) Pub. Date: Feb. 6, 2014

(54) ARTICLES AND METHODS FOR THE DETECTION AND QUANTIFICATION OF ULTRAVIOLET LIGHT

(71) Applicants: Andrey Sharavara, Bronx, NY (US); Michael Tambasco, Croton on Hudson, NY (US)

(72) Inventors: Andrey Sharavara, Bronx, NY (US); Michael Tambasco, Croton on Hudson, NY (US)

(73) Assignee: PROPPER MANUFACTURING COMPANY, INC., Long Island City, NY (US)

(21) Appl. No.: 13/565,486

(22) Filed: Aug. 2, 2012

(51) Int. Cl. G01N 21/78; C08J 3/28

(52) U.S. Cl. 436/164

(57) ABSTRACT

Formulations, articles and methods for the detection and/or qualification of ultraviolet light. A chemical formulation containing a tetrazolium or formazan complex is used to make a UV sensitive compound. The formulation is used to form a chemical indicator comprising a substrate with the formulation impregnated on or in the substrate. The substrate may be any suitable material and may be coated, uncoated, or laminated. The formulation may be coated on or inserted into a substrate and will form a UV detecting indicator when applied thereto. Depending upon its composition, the formulation will undergo a color change on exposure to different types of ultraviolet radiation, such as UVA, UVB or UVC, and the color change can be correlated to the length of exposure. The indicator can be used to detect and evaluate exposure to ultraviolet light in a variety of settings depending on the specifics of the formulation.

### TECHNICAL FIELD

The subject matter described herein relates to ultraviolet sensitive formulations, chemical ultraviolet indicators, and to methods for producing such chemical ultraviolet indicators comprising the formulations, as well as to the use of indicators so formed in the detection and evaluation of exposure to ultraviolet radiation in the UVA, UVB, and/or UVC range. The formulations can be used to create a liquid, ink cream, aerosol, gel or paint that can be used to detect and evaluate exposure to ultraviolet radiation. The indicators find uses in detecting and quantifying ultraviolet radiation from, for example, sunlight, tanning beds, ultraviolet curers, disinfectors and other sources of ultraviolet radiation.

### BACKGROUND OF THE INVENTION

The ultraviolet region of the electromagnetic spectrum is that portion of the spectrum extending between x-rays and visible light. It comprises the wavelengths between 10 nm and 400 nm. The wavelengths constituting ultraviolet radiation can be divided into four groups. UVA radiation is defined as the region between 320 nm and 400 nm. UVB radiation is between 280 nm and 320 nm. UVC radiation is between 200 nm and 280 nm and the vacuum ultraviolet region is between 10 nm and 200 nm.

It is desirable to detect the presence, intensity and/or duration of ultraviolet radiation in various circumstances due to the harmful nature of such radiation. For instance, exposure to UVA and UVB radiation can cause cancer, damage the eyes and skin and has the potential to cause cataracts or photokeratitis of the eye's lens, hyperpigmentation or erythema in the skin, or intense burns. Doses of low intensity or duration can still accelerate aging of the skin, cause burns, or lead to cancer if the lower doses are repeated often. UVC exposure from sunlight is limited by the absorbing effects of the ozone layer; however, UVC exposure can also result from the use of germicidal UV lamps.

Ultraviolet exposure of any wavelength can be harmful to individuals regardless of skin type; however, the effects of UV can be particularly damaging for individuals with lighter skin tones and for children. Epidemiological evidence that links the exposure of children to ultraviolet radiation to skin cancer later in life has been found (Volkmer, B., Greinert, R. UV and Children's Skin, Progress in Biophysics and Molecular Biology, 107(3), 386-388, 2011). Epidemiological evidence has also been found that shows that lighter skin is more sensitive to UV and is more damaged by UV exposure than darker skin tones (Yamaguchi, Y., Takahashi, K, Zmudzka, B., Kornhauser, A., Miller, S. A., Tadokoro, T., Werner Berens, Beer, J. Z., Hearing, V. J., “Human skin responses to UV radiation: Pigment in the upper epidermis protects against DNA damage in the lower epidermis and facilitates apoptosis”, The FASEB Journal. 20, 1486-1488. 2006).

While exposure to UV via sunlight is the most common vehicle for exposure, there are a variety of routes of UV exposure that offer hazards that are similar to sunlight. For instance, tanning beds utilize lamps that primarily release UVA radiation with a small amount of UVB and attempt to emulate sunlight. Tanning beds offer the same health risks as sunlight and while many tanning beds offer timers to regulate exposure and can regulate lamp output according to skin type, overexposure is a common occurrence. Additionally, UV curing is used in the paint and coating industry and commercially available inks, paints and nail polishes can be cured by exposure to UVA radiation. Further, ultraviolet disinfection or germicidal irradiation makes use of UVC radiation to kill microorganisms and is used in a variety of settings including food preparation, hospitals, air purification and water/tank purification. Generally, UVC radiation used for these application remains on and no timers or exposure meters are used. Although some curing lamps have timers, many do not. Typically, timers are not useful, as the level of UV exposure will change as the distance from the UV source changes; therefore, it is desirable to have a means of evaluating radiation exposure without the use of a timer. Additionally, even with steps taken to limit exposure, it is valuable to have a means of detecting UVC radiation for safety reasons or for keeping records of individual exposure.

Per the discussion above, recent studies have shown that ultraviolet radiation can be used to eradicate Methicillin-resistant Staphylococcus aureus, or “MRSA”. MRSA is any strain of Staphylococcus aureus that is resistant to beta-lactam antibiotics (including penicillins) and cephalosporins (including cephalexins). This antibiotic resistance causes MRSA infections to be difficult to treat. Outbreaks can be fatal, and outbreaks in hospitals and nursing homes are particularly dangerous. Because of the difficulty associated with treating MRSA, its prevention is becoming increasingly important. While conventional approaches to disinfection are not always effective, UVC radiation has been shown to be successful at preventing the spread of MRSA. Recent studies have shown that MRSA can be eradicated by exposure to ultraviolet radiation (UVC) with a wavelength of 254 nm (Rao, B. K., Kumar, P., Rao, S., Gurung, B. “Bactericidal Effect of Ultraviolet C (UVC), Direct and Filtered Through Transparent Plastic, on Gram-positive Cocci: An In Vitro Study,” Ostomy Wound Management, 57(7), 46-52, 2011). This is especially promising as ultraviolet radiation can be applied easily and quickly.

One problem that arises when disinfecting in the case of MRSA is making sure that all impacted areas have been sufficiently exposed to UVC radiation. Current technology for detecting exposure to radiation of this specific wavelength range consists of expensive UV meters that are large and difficult to place in low exposure locations. These meters are also incapable of displaying records of anything other than the current conditions without connections to computers and appropriate software. The compositions, articles and methods described and claimed herein provide for detecting UVC exposure over time and, for example, can be used to verify the UVC exposure of an area that is being irradiated. The articles offer a cost effective means for providing a permanent record of exposure to UVC radiation, means for detecting exposure without exposing personnel and means for verifying that UVC radiation has reached locations that may be difficult to monitor. Recent work has also shown that UVC radiation can reduce MRSA bacterial load and promote wound healing (Thai, T. P., Houghton, P. E., Keast, D. H., Campbell, K. E., Woodbury, M. G., “Ultraviolet Light C in the Treatment of Chronic Wounds with MRSA: A Case Study.” Ostomy Wound Management, 48(11), 52-60, 2002).

Because of the health risks, such as cancer, posed by the presence of ultraviolet radiation in these situations, it is important to monitor the radiation that is absorbed. Increasing awareness of the role that ultraviolet radiation plays in the development of cancers and other skin and eye disorders has lead to research regarding means for assessing UV exposure. Current monitoring technology includes the use of meters to detect UV radiation. Meters vary greatly in price and the cheaper meters are restricted to immediate intensity measurements only. Most meters can be filtered and restricted to detection of a sample of UV radiation and can display the radiance or irradiance of a UV source, but they do not show accumulated exposure. The downside to inexpensive meters is that the devices themselves offer no means of record keeping, and therefore, most commercial meters are unable to account for fluctuations as they only make instantaneous readings and do not record total exposure over time. Another downside is that the level of UV may be transient and extremely high exposure levels can be missed if they occur after the machine is turned off or not read. While more expensive meters may offer the capacity for data logging, they become difficult and costly to operate, maintain, calibrate and manufacture. It is also impractical for individuals to carry large meters on their person when exposed to sunlight or tanning beds. All meters have the downsides of potentially being out of calibration and producing faulty readings, or being restricted in the location where they can be placed (for example, inside a UV nail polish curer) because of the size of the meter. It is also impossible to put meters that are instantly readable in enclosed places, such as disinfection chambers or dryers, that have no viewing window (since viewing windows could allow for UV exposure). In these instances a disinfection indicator is an extremely useful tool for estimating the amount of UV exposure.

Plastic films for use in a UV badge actinometer have been developed using polysulphones (Davis, A., Deane, G. H. W. & Diffey, B. L., “Possible dosimeter for ultraviolet radiation,” Nature, 261, 169-170, 1976); however, polysulphone based dosimeters are reversible and are therefore undesirable due to their inability to accurately measure intermittent doses and cannot be stored for record keeping purposes. Diazo compounds (Jackson, S. A., “A film badge dosimeter for UV-A radiation”, J. Biomed. Eng. 2, 63-64, 1980) have also been used, but they are only sensitive to UVA radiation, they require additional hazardous chemical processing to provide results, and completely revert under prolonged or high doses of UVA exposure. Polyvinyl chloride films containing photosensitive compounds (Diffey, B. L., Davis, A., Johnson, M., Flarrington, T. R., “A dosimeter for long wave ultraviolet radiation.” Br. J. Dermatol. 97, 127-130. 1977) have been used; however, these PVC based thin films do not respond to exposure at 254 nm (and therefore cannot be used to detect germicidal radiation), and show nearly no change in response to UV radiation in the range of approximately 300 to 350 nm. The materials used to prepare the films also interfere with the detection of ultraviolet radiation, such that the films can only be used to detect low radiation doses of under 50 J/cm², whereas the typical dose for tanning or skin treatments can be in the hundreds of J/cm² (Carlin, C. S., Callis, K. P., Krueger, G. G. “Efficacy of acitretin and commercial tanning bed therapy for psoriasis.” Arch. Dermatol. 139, 436-442. 2003. The major downside that all thin film based approaches share is that they all require sophisticated equipment that can measure absorbance in order to determine the responses of the film to UV exposure. This equipment requires special training to use, must be regularly calibrated, and takes a skilled operator to use properly. Because of these equipment requirements, thin films cannot be used in enclosed spaces. The downsides of using thin films is that thin films are more costly to manufacture, they take longer to biodegrade (if they degrade at all) and they take up more space in landfills, many thin films cannot be as easily written on as paper substrates, the thin films transition from the processed form back towards the unprocessed state, UV sensitive thin films cannot be offset print on to contain additional information, and the sensitivity of thin films to UV radiation is difficult to adjust.

Tetrazolium salts have been used to synthesize dyes used in the creation of radiation-sensitive thin films (Pikaev, A. K., Kriminskaya, Z. K., “A new dosimetric system based on aqueous alcoholic solutions of tetrazolium salts,” Mendeleev Commun. 200. 1995). For example, 2,3,5-triphenyl tetrazolium chloride has been used to create a gamma irradiation sensitive thin film that changed from a colorless film to a pink film as the tetrazolium chloride reacted with the gamma radiation to produce triphenyl formazan.

Another example involves the use of a clear tetrazolium chloride thin film that transitions to a pink formazan thin film upon exposure to ultraviolet radiation at 201 nm, 249 nm, 299 nm and 366 nm via a UV catalyzed reduction (Ebraheem, S, Abdel-Fattah, A A, Said, F I & Ali, Z I, “Polymer based triphenyl tetrazolium chloride films for ultraviolet radiation monitoring”, Rad. Phys. Chem., vol. 57, pp. 195-202. 2000). This type of thin film is designed to be used as a dosimeter, wherein the thin film is placed inside a device that can monitor the color change by measuring the absorbance of a beam of light of a single wavelength that is passed through the film.

There are several downsides to this approach. For instance, the pink film will undergo reversion back towards the colorless state, the change from a colorless to a colored state is imprecise because of the color reversions that the films undergo when the ultraviolet source is removed therefrom (requiring additional equipment and calibrations to evaluate), the film cannot be adjusted to respond to different lengths of exposure, a single film cannot be modified to respond to different wavelengths of ultraviolet light, the thin film has restricted applications, and the performance of the film is sensitive to small fluctuations in temperature and humidity.

A significant downside is that after undergoing a transition from colorless to pink, the prior art devices will undergo reversion from the processed pink form back towards the original colorless state. The reversion will occur under several conditions, including when the source of the ultraviolet radiation is removed, or when the thin film is stored under humid conditions. The reversion is undesirable as it can provide unclear results when analyzed. For example, a thin film that was sufficiently exposed but which has undergone reversion after the UV source was removed would be indistinguishable from a thin film that was not exposed to the UV source long enough to undergo the colorless to pink transition. This reversion prevents such tetrazolium based thin films from being able to demonstrate a color change based upon the total accumulated dose of ultraviolet exposure. The thin films are also sensitive to the entire range of ultraviolet radiation and cannot be made to differentiate between exposures to UVA/UVB/UVC.

Another downside is that the transition from colorless to colored that undergoes any degree of reversion is imprecise and cannot be evaluated by the human eye, instead requiring complex equipment and a detailed procedure. Specifically, evaluating the thin films requires that the entire UV spectrum of the film be taken before and immediately after the film is exposed to UV radiation. Therefore, evaluating the thin film requires a machine capable of detecting wavelengths and intensities of transmitted radiation and both the machine and film must be calibrated prior to use. The thin film must have an initial spectrum taken prior to exposure to ultraviolet radiation. After the exposure is complete, another measurement is made and then compared to the initial result. This approach is generally not useful for the general population for detecting exposure to sunlight or UV radiation from tanning beds or germicidal lamps as the individual needs special training, skills, and equipment, and must operate the equipment while being exposed to the radiation. Another downside is that the reactivity of the thin films to UV radiation cannot be readily adjusted. Specifically, the time required to cause the film to transition from colorless to pink cannot be modified assuming that the intensity of wavelength of the ultraviolet source remains constant.

An additional downside is that differentiating between exposures to UVA/UVB/UVC requires the use of a second thin film, which complicates the measurement procedure and can lead to faulty readings if the films are not precisely arranged. Also, the static reaction to ultraviolet as well as the fact that the films cannot be printed on any substrate, as that would impede the transmission of the radiation used to calibrate the film's reaction, prevents films made using this approach from being modified to react differently depending on the desired application. Lastly, Kovacs, A., et al., “Radiation chemical reactions of tri-phenyl tetrazolium chloride in liquid and solid state”, Radiat. Phys. Chem. 47, 483-486 (1996) demonstrates that the films are sensitive to both temperature and humidity. Small fluctuations in either parameter can result in less prominent color changes that may be confused with the results obtained with lower radiation doses or shorter exposure periods. Also, as previously discussed, the UV spectra of the thin film must be measured both prior to and immediately after exposure of the thin film.

Tetrazolium chloride has also been used to make thin films that will change color when exposed to electron beam radiation (Kovacs, A., Wojnarovits, L., Ebraheem, S., McLaughlin, W. L., Miller, A., “Radiation chemical reactions of tri-phenyl tetrazolium chloride in liquid and solid state,” Radiat. Phys. Chem. 47, 483-486. 1996). Tetrazolium chloride has also been mixed with poly(vinyl alcohol) and poly(vinyl butyral) to produce UV sensitive thin films (Ebraheem, S, Abdel-Fattah, A A, Said, F I Ali, Z I, “Polymer based triphenyl tetrazolium chloride films for ultraviolet radiation monitoring”, Rad. Phys. Chem., vol. 57, pp. 195-202. 2000). The films were exposed to radiation at 201 nm, 249 nm, 299 nm and 366 nm, whereupon they changed from a colorless to a pink film.

There are several downsides to this approach as well to using these tetrazolium based thin films. The first is that the tetrazolium based thin films do not demonstrate a color change based on the total accumulated dose as the thin films show some reversion to the colorless form when the ultraviolet source is removed. Thus, the thin film based approach would provide unclear results if the ultraviolet radiation was removed for a lengthy period of time (a power outage could cause such an incident). Another downside of this approach is that the change in appearance from “colorless” to “pink” is unclear and does not allow for quick visual analysis of the film. A transition from colorless to colored is imprecise as it is hard to gauge when a color is dark enough to be considered an end point, in particular because these films undergo some degree of reversion back towards the colorless form after the radiation source is removed, and therefore, analysis of the film cannot be performed without the use of a spectrophotometer or other means of measuring color density. Another downside to the thin film approach is that the films have a static reaction to ultraviolet and the reaction cannot be modified to react differently depending on the desired application. It would be desirable to have a simple to use indicator that will react after several minutes of exposure (for example, when UV curing nail polish) as well as a separate indicator that will react after several hours of exposure (for example, when tanning outside via sunlight exposure). The indicator should require no training, special knowledge, or skill to use and evaluate. An additional downside is that the thin films will react to all wavelengths of ultraviolet radiation and cannot be used to distinguish between UVA and UVC exposure. Also, the thin films created were sensitive to humidity and require calibration measurements prior to use as a UV dosimeter, therefore, the device would not be viable in any environment where humidity fluctuations are common, such as industrial printing complexes. Another limitation of the previous approach is that the thin film is restricted to radiation doses between 0.04 and 1.5 J/cm², where doses can range up to hundreds of J/cm².

Test strips, indicators, or indicator inks that indicate the presence of a sterilant/disinfectant via a color or color intensity change are known in the art. Examples include pH testers, steam sterilization indicators, hydrogen peroxide indicators and gamma radiation indicators. Chemical indicators are inexpensive, single-use disposable devices that accurately show the presence of an analyte and can be disposed after use or retained for record-keeping purposes. They can also be evaluated against a color standard to provide quantitative information regarding exposure.

The compositions, articles of manufacture and methods described and claimed herein provide an ultraviolet indicator that overcomes the disadvantages associated with the prior art. The indicator formulation can be applied to a substrate that can be retained for personal records of UV exposure, and will be inexpensive when compared to thin films or UV meters. Alternatively, the formulation can be maintained as a liquid, ink, gel, aerosol, cream or paint and applied to any suitable surface. Unlike UV meters, the indicators can be of a small size that can be placed in locations that are otherwise difficult or impossible to monitor. Indicators that aren't thin films can be produced using substrates that may be written or printed on using conventional methods and used to write notes, dates of manufacture, lot numbers, storage conditions or other important information. Unlike previous examples disclosed in the prior art, the current formulation has a distinct color change that can detect different types of ultraviolet radiation and that can be quickly evaluated and that is stable to environmental fluctuations. Unlike the examples of the prior art, for this formulation the processed color after exposure to ultraviolet radiation is stable against any reversion back towards the unprocessed color.

### SUMMARY

The compositions and methods described and claimed herein provide an ultraviolet indicator formulation that overcomes the disadvantages associated with the prior art. The methods of this invention prevent reversion, have a distinct color to color transition, and the formulation can be readily adjusted to react to different wavelengths and time periods of UV exposure, can detect different types of ultraviolet radiation, and can be placed on a variety of substrates and evaluated using the human eye instead of requiring a machine that can detect transmitted or absorbed light. The approach described herein includes several methodologies for altering the reaction mechanism in order to provide a more distinct color change that will no longer undergo any reversion.

Furthermore, as the present formulation also avoids a tetrazolium to formazan transition, the formulation is no longer sensitive to changing environmental or temperature conditions. One way to protect the tetrazolium/formazan compound against reversion or loss of sensitivity while providing a more distinct color change is to utilize a reduction of the azo groups of the tetrazolium or formazan compound. The tetrazolium/formazan compound can be reduced to a compound with a yellow color through inclusion of hydrogen donating compounds. Some suitable compounds are protic acids or proton donating polymeric binders, as these compounds will readily donate protons. The inclusion of a protic acid or an appropriate polymeric binder changes the mechanism to a reduction that results in a stable product that will not revert back to the tetrazolium or formazan compound.

In an alternate embodiment, the tetrazolium/formazan compound can be broken down through a radical induced photochemical reaction. This change in reaction mechanism is accomplished by including chemicals that freely form radicals, such as hydrogen peroxide. The inclusion of a radical source results in the formation of a yellow (instead of pink) product that will not revert to the colorless tetrazolium compound. Careful selection of the acid, binder, or radical source also allows for control of the rate of color change occurring upon exposure to ultraviolet radiation. The reactive components may either speed up or slow down the reaction rate allowing the invention to be used for a variety of purposes.

The formulation is further protected against reversion of the endpoint color to an intermediate or the initial color by the inclusion of a dye mordant. The dye mordant and binder form a coordination complex that protects the tetrazolium/formazan compound against environmental effects like humidity or temperature. Careful selection allows for the dye mordant to be the same compound as the proton source, thus simplifying the mixing process. The visualization of a colorless to color transition can be improved by the inclusion of an additional non-reactive dye component. Care must be taken to select a dye that will not change color when exposed to ultraviolet light, high humidity, temperature, or pH fluctuations. Also, the dye must not react with any of the components of the mixture, including the tetrazolium/formazan compound, dye mordant, binder, protic acid or radical source.

Thus in one embodiment the present invention is directed to a formulation for evaluating exposure of a surface to ultraviolet (i.e., UV) radiation. The formulation comprises: (a) at least one material selected from the group consisting of tetrazolium compounds and formazan compounds, which compounds react in the presence of ultraviolet light, the reaction being evidenced by (i) an irreversible color change of the at least one compound from a first color to a second color, the second color being selected from the group consisting of a shade of the first color that is perceptibly darker than the first color; a shade of the first color that is perceptibly lighter than the second color; and a distinctly different color from the first color, or (ii) by an irreversible change from a colored state to a substantially colorless state or vice versa; (b) a polymeric binder that binds the formulation to a substrate; (c) a solvent that solubilizes components of the formulation; and (d) an additive comprising at least one of a proton-donating acid compound and a compound that will undergo photolysis in the presence of ultraviolet light to generate free radicals. If carefully selected, the binder may also serve as the proton-donating compound. The additive stabilizes the color change of the at least one material by preventing reversion from the second color to the first color or from the substantially colorless state back to the colored state.

In an embodiment of the formulation described above, the tetrazolium compound comprises a tetrazolium salt having the general formula:

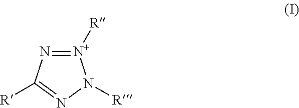

wherein R′, R″ and R′″ are each aromatic groups, which aromatic groups may be the same or different from one another, and wherein the aromatic groups are substituted or unsubstituted. In one embodiment the aromatic groups are all the same. In another embodiment at least one of the aromatic groups is a phenyl group.

In another embodiment the tetrazolium compound of formula (I) as shown above further comprises an anion (X⁻), wherein the anion may be any anion. In one embodiment the anion is Cl⁻.

Further to the above, in another embodiment the formazan compound comprises a formazan dye having the general formula:

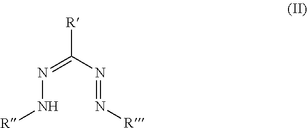

wherein R′, R″ and R′″ are each aromatic groups, which aromatic groups are the same or different from one another, and wherein the aromatic groups may be substituted or unsubstituted. In one embodiment all of the aromatic groups are the same. In another embodiment at least one of the aromatic groups is a phenyl group.

In particular, the tetrazolium compound described above may be selected from among, for example, the following non-limiting examples:
2,3,5-triphenyltetrazolium chloride;
2-(2-methylphenyl)-3,5-diphenyl-2H-tetrazolium tetrafluoroborate;
2-(4-chlorophenyl)-3,5-diphenyl-2H-tetrazolium tetrafluoroborate;
2,3-diphenyl-5-(4-chlorophenyl)-2H-tetrazolium tetrafluoroborate;
2-(4-iodophenyl)-3,5-diphenyl-2H-tetrazolium tetrafluoroborate;
2-(4-chlorophenyl)-3-(2-chlorophenyl)-5-(2-pyridyl)-2H-tetrazolium iodide;
2,3-diphenyl-2H-tetrazolium sulfate;
2-(2-methoxyphenyl)-3,5-diphenyl-2H-tetrazolium tetrafluoroborate;
2,3-diphenyl-5-methyl-2H-tetrazolium chloride;
2,3-diphenyl-5-dodecyl-2H-tetrazolium chloride;
5-(3-iodophenyl)-2,3-diphenyl-2H-tetrazolium chloride;
5-cyano-2,3-diphenyl-2H-tetrazolium chloride;
5-acetyl-2,3-diphenyl-2H-tetrazolium chloride;
2,5-diphenyl-3-(4-tolyl)-2H-tetrazolium bromide;
2,5-diphenyl-3-(4-biphenylyl)2H-tetrazolium chloride;
2,3-diphenyl-5-(2-chlorophenyl)-2H-tetrazolium iodide;
5-(3,4-dimethoxyphenyl)-3-(4-nitro-phenyl)-2-phenyl-2H-tetrazolium iodide;
2,3-diphenyl-5-nitro-2H-tetrazolium chloride;
2,3-diphenyl-5-(2-naphthyl)-2H-tetra-zolium chloride;
Ethylenebis[5-(2,3-diphenyl-2H-tetrazolium chloride)];
1,6-hexylenebis[5-(2,3-diphenyl-2H-tetrazolium chloride)];
1,4-phenylenebis[5-(2,3-diphenyl-2H-tetrazolium chloride)];
4,4′-biphenylylenebis[2-(5-methyl-3-phenyl-2H-tetrazolium chloride)];
4,4′-phenylene sulfoxide-bis[2-(3,5-diphenyl-2H-tetrazolium chloride)];
4,4′-biphenylylenebis[2-(3-diphenyl-5-(3,4-methylenedioxyphenyl-2H-tetrazolium chloride)];
2-phenyl-3-(4-nitrophenyl)-5-undecyl-2H-tetrazolium chloride;
2,3-diphenyl-5-carbethoxy-2H-tetrazolium chloride;
5-carbohexoxy-2,3-diphenyl-2H-tetrazolium chloride;
5-acetyl-2-phenyl-3-(4-chlorophenyl)-2H-tetrazolium tetrafluoroborate;
2,3-diphenyl-5-(1-naphthyl)-2H-tetrazolium bromide;
2-(2,4,6-trichlorophenyl)-3,5-diphenyl-2H-tetrazolium tetrafluoroborate;
2-(3,4-dichlorophenyl)-3,5-diphenyl-2H-tetrazolium tetrafluoroborate 2,3-diphenyl-5-(3-nitrophenyl)-2H-tetrazolium tetrafluoroborate;
2-(3-nitrophenyl)-3,5-diphenyl-2H-tetrazolium tetrafluoroborate;
2,3-diphenyl-5-(4-nitrophenyl)-2H-tetrazolium tetrafluoroborate
2,5-Diphenyl-3-(α-naphthyl)tetrazolium chloride);
3,3′-(3,3′-Dimethoxy[1,1′-biphenyl]-4,4′-diyl)-bis(2,5-diphenyl-2H-tetrazolium)dichloride;
3-(4,5-Dimethyl-2-thiazolyl)-2,5-diphenyl-2H-tetrazolium bromide;
3,3′-(3,3′-Dimethoxy-4,4′-biphenylene)bis[2,5-bis(p-nitrophenyl)-2H-tetrazolium chloride];
2-(2′-Benzothiazolyl)-5-styryl-3-(4′-phthalhydrazidyl)tetrazolium chloride;
2,2′-Di(p-nitrophenyl)-5,5′-di(p-thiocarbamylphenyl)-3,3′-(3,3′-dimethoxy-4,4′-biphenylene)ditetrazolium chloride;
2,2′-bis(4-Nitrophenyl)-5,5′-diphenyl-3,3′-(3,3′-dimethoxy-4,4′-diphenylene)ditetrazolium chloride;
2-(4-Iodophenyl)-3-(4-nitrophenyl)-5-phenyl-2H-tetrazolium chloride;
2,3-Bis(2-methoxy-4-nitro-5-sulfophenyl)-2H-tetrazolium-5-carboxanilide; and
3,3′-(3,3′-Dimethoxy-4,4′-biphenylene)bis[5-(3-nitrophenyl)-2-phenyl-2H-tetrazolium chloride].

In another embodiment the formazan compound may be selected from among, for example, the following non-limiting examples:
1,3,5-triphenyltetrazolium formazan;
1-(4,5-Dimethylthiazol-2-yl)-3,5-diphenylformazan;
1-(4-Iodophenyl)-5-(4-nitrophenyl)-3-phenylformazan; and
1-Carbamimidoyl-3-phenyl-5-(1H-tetrazol-5-yl)formazan.

In an embodiment of the invention the formulation is produced in a form selected from the group consisting of a liquid, an ink, a cream, an aerosol, a gel and a paint.

In another embodiment the proton donor of the formulation described above is at least one selected from the group consisting of an acid and a polymeric binder that donates protons.

In another embodiment the radical-forming material of the formulation described above is a species that will form free radicals via photolysis when exposed to ultraviolet radiation. Accordingly, the radical-forming material is at least one selected, in a further embodiment, from the group consisting of peroxide, oxalate, nitrate and metallocene. More particularly, in further embodiments the radical-forming material is selected from the group consisting of hydrogen peroxide, benzoyl peroxide, tert-butyl hydroperoxide, dimethyl oxalate, ferrioxalate, sodium oxalate, sodium nitrate and ferrocene.

In another embodiment of the invention, the binder, in addition to binding the formulation to a substrate, additionally serves to protect an endpoint color of the formulation against reversion toward an initial color. In a further embodiment the binder is at least one selected from the group consisting of acrylates, acrylic acids, celluloses, styrenic resins, phenolic resins and plastics. In another embodiment the binder is selected from the group consisting of polymethacrylic acid, methyl cellulose, polystyrene resins, polyvinyl chloride, polymethacrylate, ethyl cellulose and phenol formaldehyde resins.

In a further embodiment the solvent is at least one selected from the group consisting of an aliphatic alcohol, a methylated spirit, a glycol, water, an ether, an ester, a ketone, an alkane, a sulfoxide and an amine. In a more particular embodiment the solvent is at least one selected from the group consisting of methanol, ethanol, propanol, butanol, 2-ethyl-1-hexanol, cellosolve, cellosolve acetate, dimethylsulfoxide, naptha, glycerine, water, 1-methoxy-2-propanol, isopropyl acetate, ethanolamine, tetrahydrofuran and acetone.

In another embodiment of the formulation described above, the formulation further comprises an additive that stabilizes the reaction by donating protons to tetrazolium and formazan moieties. In one embodiment the additive is at least one protic acid selected from the group consisting of substituted benzoic acids, acetic acids, ascorbic acids, hydroquinones, mineral acids and citric acids. Examples of such additives include, but are not limited to, organic acids such as ascorbic acid, 2,4-dihydroxybenzoic acid, tannic acid, gallic acid, hydroquinone, citric acid, ethylenediaminetetraacetic acid or phloroglucinol carboxylic acid. The binder may also serve as the proton donating compound, and may be at least one selected from the group consisting of acrylic acids and celluloses. Non-limiting examples of proton donating polymers include polymethacrylic acid and methyl cellulose. In another embodiment the additive also serves as a mordant that enhances brightness of the second color by forming a complex with at least one of the formazan and tetrazolium compounds.

In another embodiment the above-described formulation further comprises a non-reactive dye that enhances the distinction between the first color and the second color. The dye is unreactive to ultraviolet light and pH.

In another embodiment the at least one of a tetrazolium compound and a formazan compound is present in the formulation in an amount below about 5% by weight, the polymeric binder is present in an amount between about 2%-50% by weight and the solvent is present in an amount between about 50-96% by weight. In a particular embodiment, the additive is a radical-forming material and such radical-forming material is present in the formulation in an amount of between about 0.1% and 10% by weight. In an alternate embodiment, the additive is a proton donor and the proton donor is present in the formulation in an amount of between about 0.1% and 10% by weight.

Another embodiment of the present invention is a chemical UV indicator comprising the formulation as described above, wherein the formulation is in a form selected from the group consisting of a liquid, an ink, a cream, an aerosol, a paint and a gel and wherein the formulation is at least one of printed on a surface of a substrate and impregnated into a substrate.

In one embodiment of the chemical UV indicator, prior to application of the formulation to the substrate the substrate is supplied with at least one layer of a coating material and the formulation is applied upon an uppermost one of the at least one coating layer.

In a particular embodiment the formulation is in the form of an ink and the substrate may be printed with multiple inks.

In additional embodiments of the invention the substrate is formed of at least one material selected from the group consisting of skin, hair, fingernail, stone, wood, paper, plastic, laminate, resin, metal, shellac, leather, fibers, fabric, glass, polymers and combinations thereof.

In one embodiment of the invention the substrate is a clear substrate and the color change is from a first colored state to a second, substantially colorless state. In another embodiment of the invention the color change is from a first colorless state to a second, colored state. In an alternate embodiment the substrate is a colored substrate, wherein the color change is from a first colored state to a second, substantially colorless state and wherein the color of the substrate may be observed through the substantially colorless formulation. In another embodiment the substrate is white in color and the white color of the substrate may be observed through the substantially colorless formulation. In another embodiment, the substrate is colored or white, and the color change is from a first colored state to a second colored state.

In another embodiment the indicator is coated on at least one surface thereof with one or more coating layers, thus forming a laminate upon the substrate. The at least one layer comprising the laminate may, in some embodiments, be formed from a material selected from the group consisting of polyester/polyethylene, polypropylene and nylon. In a particular embodiment the laminate has a thickness of between about 1.2 and 10 mil.

In another embodiment the substrate is provided with an adhesive backing to facilitate adherence of the chemical UV indicator to a surface.

In a particular embodiment of the chemical UV indicator the formulation is formed with a tetrazolium compound comprising a tetrazolium salt having the general formula:

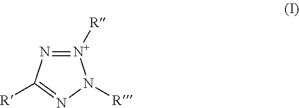

wherein R′, R″ and R′″ are each aromatic groups, which aromatic groups may be the same or different from one another, and wherein the aromatic groups are substituted or unsubstituted. In one embodiment the aromatic groups are all the same. In another embodiment at least one of the aromatic groups is a phenyl group. In a further embodiment the tetrazolium compound further comprises an anion (X⁻), wherein the anion may be any anion.

In another particular embodiment of the chemical UV indicator, the formulation contains a formazan compound comprising a formazan dye having the general formula:

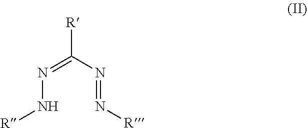

wherein R′, R″ and R′″ are each aromatic groups, which aromatic groups are the same or different from one another, and wherein the aromatic groups may be substituted or unsubstituted. In one embodiment all of the aromatic groups are the same. In another embodiment at least one of the aromatic groups is a phenyl group.

In one embodiment the additive used in forming the formulation includes a proton donor and the proton donor is at least one selected from the group consisting of an acid and a polymeric binder that donates protons or alkyl groups.

In another embodiment the additive includes a radical-forming material and the material is a species that will form free radicals via photolysis when it is exposed to ultraviolet radiation.

In another embodiment of the chemical UV indicator the binder used in the formulation is at least one selected from the group consisting of acrylates, acrylic acids, celluloses, styrenic resins, phenol formaldehyde resins and plastics. In further, particular embodiments the binder is at least one selected from the group consisting of polymethacrylate, polymethacrylic acid, methyl cellulose, polystyrene resins, polyvinyl chloride and phenolic resins. In another embodiment the solvent is at least one selected from the group consisting of an aliphatic alcohol, a methylated spirit, a glycol, water, an ether, an ester, a ketone, an alkane, a sulfoxide and an amine. In a still further embodiment the solvent is at least one selected from the group consisting of methanol, ethanol, propanol, butanol, 2-ethyl-1-hexanol, cellosolve, cellosolve acetate, dimethylsulfoxide, naptha, glycerine, water, 1-methoxy-2-propanol, isopropyl acetate, ethanolamine, tetrahydrofuran and acetone.

In another embodiment the formulation used in forming the chemical UV indicator further comprises an acid additive that stabilizes the reaction by donating protons to tetrazolium or formazan moieties. In one embodiment the acid additive is at least one protic acid selected from the group consisting of substituted benzoic acids, acetic acids, ascorbic acids, hydroquinones, mineral acids and citric acids. In a further embodiment the acid additive also serves as a mordant that enhances brightness of the second color following a color change of the formulation by forming a complex with at least one of the formazan and tetrazolium compound.

In another embodiment of the chemical UV indicator the formulation further comprises a non-reactive dye that enhances distinction between the first color and the second color, wherein the dye is unreactive to ultraviolet light and pH.

In another embodiment the at least one of a tetrazolium compound and a formazan compound is present in the formulation in an amount below about 5% by weight, the polymeric binder is present in the formulation in an amount between about 2%-50% by weight and the solvent is present therein in an amount between about 50-96% by weight.

In one embodiment of the chemical UV indicator the additive to the formulation is the radical-forming material and the radical-forming material is present therein in an amount between about 0.1% and 10% by weight.

A particular embodiment of the invention constitutes a chemical UV indicator for evaluating exposure of a surface to ultraviolet (UV) radiation, wherein the indicator comprises: (a) a formulation in the form of an ultraviolet sensitive liquid, gel, fluid, ink, aerosol, paint or cream, the formulation comprising at least one material selected from the group consisting of tetrazolium compounds and formazan compounds. The compounds react in the presence of ultraviolet light. The reaction is evidenced by an irreversible color change of the at least one compound from a first color to a second color. The second color is (i) one selected from the group consisting of a shade of the first color that is perceptibly darker than the first color; a shade of the first color that is perceptibly lighter than the first color; and a distinctly different color from the first color; or, (ii) by an irreversible color change from a colored state to a substantially colorless state or vice versa. The indicator then further comprises (b) a substrate, wherein the formulation is at least one of printed on a surface of the substrate and impregnated into the substrate. The formulation, then, further comprises: (i) a polymeric binder that binds the formulation to the substrate; (ii) a solvent that solubilizes solid components of the formulation; and (iii) an additive comprising at least one of a proton donating compound and a compound that will undergo photolysis in the presence of ultraviolet light in order to generate free radicals. The additive stabilizes the color change of the at least one compound by preventing reversion from the second color back to the first color, or from the substantially colorless state to the colored state.

In a further embodiment the above-described formulation additionally comprises an acid additive that stabilizes the reaction by donating protons to tetrazolium or formazan moieties. Alternately, in another embodiment the formulation further comprises a non-reactive dye that enhances distinction between the first color and the second color. The dye is unreactive to ultraviolet light and pH.

In a particular embodiment the formulation is in the form of an ink and the substrate is printed with multiple such inks.

In one embodiment the substrate is formed of a material selected from the group consisting of skin, hair, fingernails, stone, wood, paper, plastic, laminate, resin, metal, shellac, fibers, leather, fabric, glass, polymers and combinations thereof.

In another embodiment the formula is printed on a substrate, and the substrate (with printed ink) is then coated with one or more laminate layers, thus forming a laminate upon the substrate. In a particular embodiment the at least one layer comprising the laminate is formed from a material selected from the group consisting of polyester/polyethylene, polypropylene and nylon. In a further embodiment the laminate has a thickness of between about 1.2 and 10 mil. In another embodiment the substrate is provided with an adhesive backing to facilitate adherence of the chemical UV indicator to a surface.

A further embodiment of the invention is a method of verifying exposure of a surface to sunlight, wherein the method comprises providing the chemical UV indicator as described above on or at least adjacent to the surface, in a path of sunlight during a term of exposure of the surface to the sunlight. As used herein, the term “adjacent” is used to refer to a location that is sufficiently close to the substrate such that the indicator is exposed to the same wavelength and dose of UV radiation the surface is exposed to.

Another embodiment is a method of verifying exposure of a surface to germicidal Ultraviolet C (UVC) radiation used to eradicate Methicillin-resistant Staphylococcus aureus and other microbial organisms. The method comprises providing the chemical UV indicator as described above on or at least adjacent the surface, in a path of the UVC radiation, during a term of exposure of the surface to the UVC radiation.

Still another embodiment of the present invention is a method of verifying exposure of a surface to at least one of Ultraviolet A (UVA), Ultraviolet B (UVB) and Ultraviolet C (UVC) radiation wherein the method comprises providing the chemical UV indicator as described above on or at least adjacent to the surface, in a path of the ultraviolet radiation, during a term of exposure of the surface to the ultraviolet radiation.

A further embodiment is a method of verifying exposure of a surface to at least one of UVA and UVB radiation from a tanning lamp wherein the method comprises providing the chemical UV indicator as described above on or at least adjacent the surface in a path of the UVA and/or UVB radiation during a term of exposure of the surface to the at least one of UVA and UVB radiation.

Another embodiment of the invention is a method for curing a material selected from the group consisting of inks, paints and cosmetics by exposure to ultraviolet radiation wherein at least one of a degree and an amount of the radiation is determined by exposing the chemical UV indicator as described above to the radiation.

An additional embodiment constitutes a method for forming a chemical UV indicator, which indicator is as described in detail above. The method comprises applying to at least one surface of a substrate a formulation adapted for evaluating exposure to ultraviolet (UV) radiation, wherein the formulation comprises: (a) at least one material selected from the group consisting of tetrazolium compounds and formazan compounds, which compounds react in the presence of ultraviolet light, the reaction being evidenced by (i) an irreversible color change of the at least one compound from a first color to a second color, the second color being one selected from the group consisting of a shade of the first color that is perceptibly darker than the first color; a shade of the first color that is perceptibly lighter than the first color; and a distinctly different color than the first color; or (ii) by an irreversible change from a colored state to a substantially colorless state or vice versa; (b) a polymeric binder that binds the formulation to a substrate; (c) a solvent that solubilizes solid components of the formulation, and (d) an additive comprising at least one of a proton donating acid compound and a compound that will undergo photolysis in the presence of ultraviolet light in order to generate free radicals. The additive stabilizes the color change of the at least one compound by preventing reversion from the second color to the first color, or from the substantially colorless state back to the colored state.

In one embodiment of the method as described above, the formulation is in a form selected from the group consisting of a liquid, an ink, a cream, an aerosol, a paint and a gel. The formulation is at least one of printed on a surface of the substrate and impregnated into the substrate.

In a particular embodiment of the method, the formulation is in the form of an ink and the substrate is printed with multiple inks. Another embodiment comprises forming the substrate from a material selected from the group consisting of skin, hair, fingernails, stone, wood, paper, plastic, laminate, resin, metal, shellac, fibers and combinations thereof.

In a further embodiment the method of the invention further comprises coating the chemical UV indicator on at least a portion of at least one surface thereof, with one or more layers to form a laminate upon the surface. In one embodiment the at least one layer comprising the laminate is formed from a material selected from the group consisting of polyester/polyethylene, polypropylene and nylon. In another embodiment the laminate has a thickness of between about 1.2 and 10 mil.

In another embodiment the method further comprises providing the laminate with an adhesive backing to facilitate adherence of the chemical UV indicator to a surface.

In a particular embodiment of the method the formulation is formed with a tetrazolium compound comprising a tetrazolium salt having the general formula:

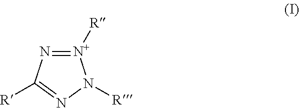

wherein R′, R″ and R′″ are each aromatic groups, which aromatic groups may be the same or different from one another, and wherein the aromatic groups are substituted or unsubstituted. In one embodiment the aromatic groups are all the same. In another embodiment at least one of the aromatic groups is a phenyl group. In a further embodiment the tetrazolium compound further comprises an anion (X⁻), wherein the anion may be any anion.

In another embodiment of the method the formulation contains a formazan compound comprising a formazan dye having the general formula:

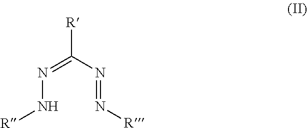

wherein R′, R″ and R″ are each aromatic groups, which aromatic groups are the same or different from one another, and wherein the aromatic groups may be substituted or unsubstituted. In one embodiment all of the aromatic groups are the same. In another embodiment at least one of the aromatic groups is a phenyl group.

### DESCRIPTION OF THE FIGURES

FIG. 1 is an exploded view of one embodiment of a chemical UV indicator according to the invention. The indicator comprises the tetrazolium or formazan based formulation (10) dried on a substrate (12). The indicator may then be coated with an optional protective coating layer (14) on any or all surfaces of the substrate;

FIG. 2 shows the color change occurring in Examples 1, 2, and 3 after exposure to UVC radiation at 254 nm with an irradiance of 5 mW/cm². The figure shows the color change as determined by a spectrometric evaluation of ΔE, as a function of exposure time (in minutes). All of the samples underwent a change that is noticeable to the human eye. The color change of Example 3 is strong enough that the example can be used as an indicator of exposure to 254 nm radiation. The figure demonstrates that the addition of an acidic additive to a formazan-based formulation can slow down the color change reaction while making the change easier to see. Also, a radical-generating species can be included to accelerate the color change reaction while enhancing visibility;

FIG. 3 shows the color change occurring in Examples 4, 5, and 6 after exposure to UVA radiation at 370 nm with an irradiance of 5 mW/cm². The figure shows the color change as determined by a spectrometric evaluation of ΔE, as a function of the logarithm of the exposure time (in minutes). The logarithm was used in order for all three examples to be viewable on the same set of axes. All of the examples underwent large color changes and can be used as indicators of the presence of UVA radiation. The figure shows that the addition of an acidic additive to a tetrazolium-based formulation can slow down the color change reaction while making the change easier to see. Also, a radical generating species can be used to accelerate the color change reaction while enhancing visibility;

FIG. 4 shows the color change occurring in Examples 7 and 8 after exposure to UVB radiation at 302 nm with an irradiance of 5 mW/cm². This figure shows the color change as determined by a spectrophotometric evaluation of ΔE, as a function of exposure time (in minutes); and

FIG. 5 shows the color change occurring in Examples 7, 8, 9, and 10 after exposure to sunlight with an average irradiance of 5 mW/cm². The figure shows the color change as determined by a spectrometric evaluation of ΔE, as a function of exposure time (in minutes). All of the examples quickly changed color and can be used to indicate direct exposure to sunlight. The figure shows that increasing the concentration of the tetrazolium/formazan complex in the mixture will result in a slightly slower color change that has a more pronounced difference between the unexposed and endpoint colors obtained after exposure.

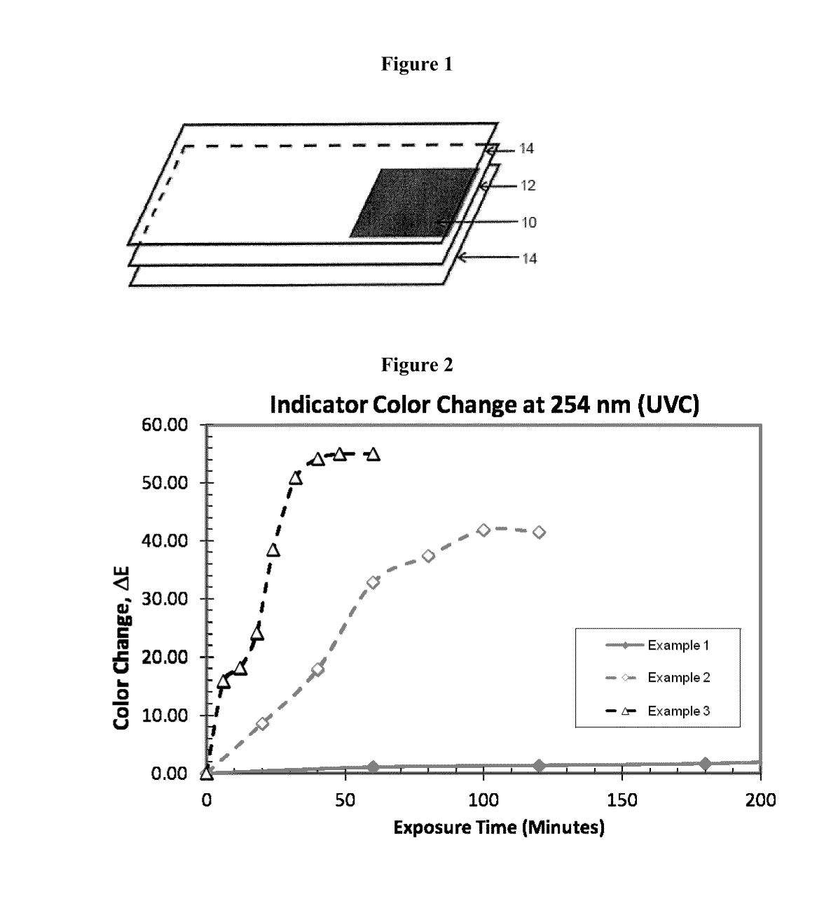

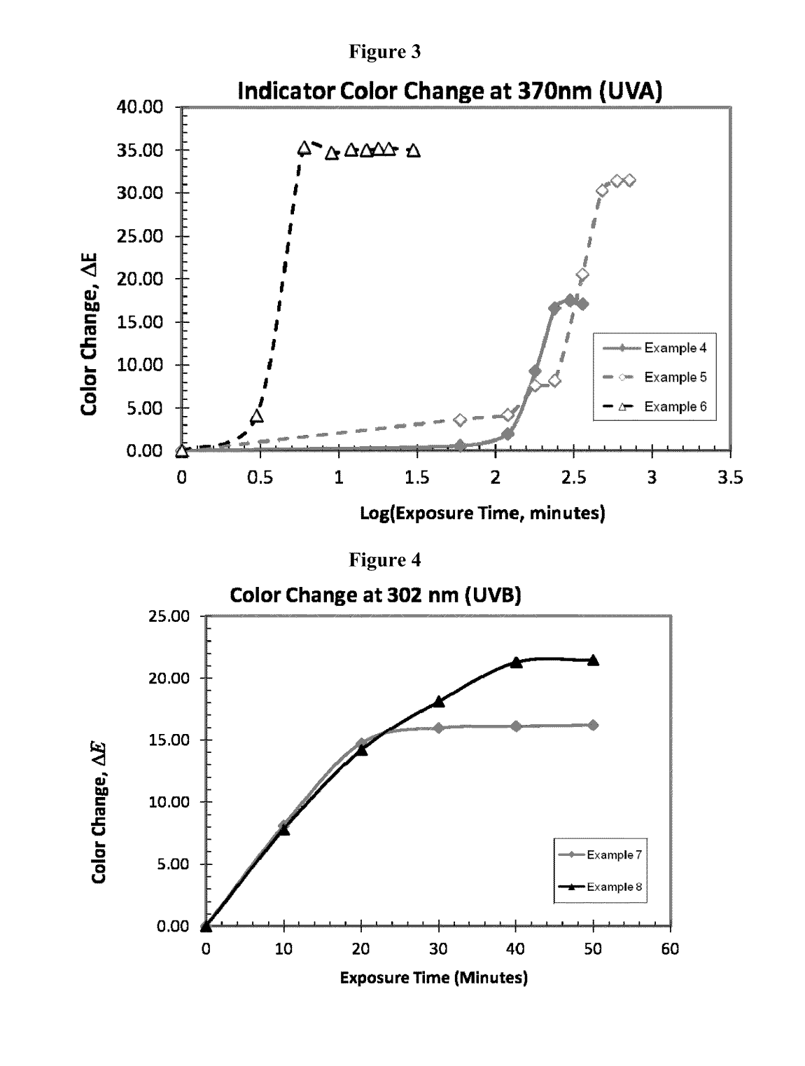

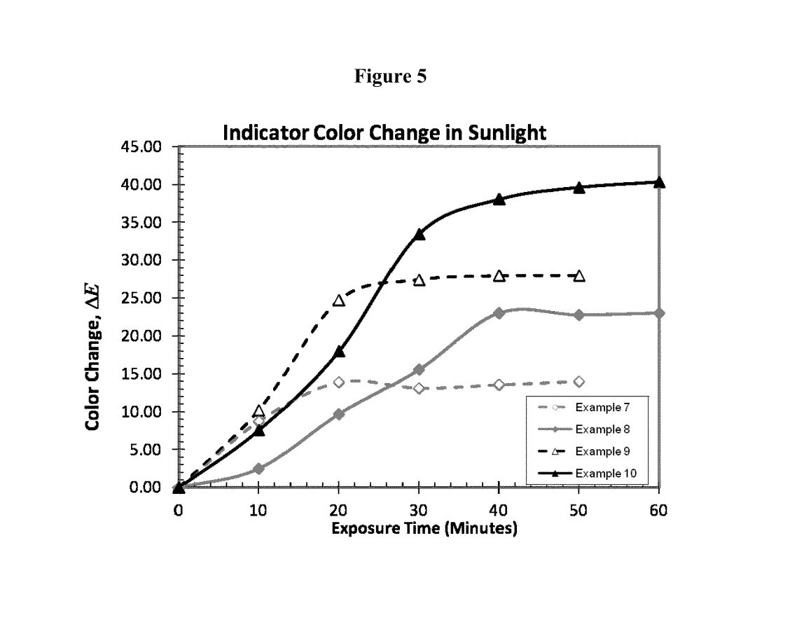

### DETAILED DESCRIPTION OF CERTAIN EMBODIMENTS OF THE INVENTION

The present invention relates to a chemical formulation that can be used to create an indicator that monitors exposure to ultraviolet radiation. Embodiments of the formulation may include such as liquids, inks, creams, paints, gels, or aerosols, wherein these materials undergo an irreversible chemical reaction resulting in a color change, i.e., from one color to another or, alternatively, from colored to substantially clear, that immediately and clearly indicates the presence of ultraviolet radiation.

The chemical indicators are comprised of a substrate coated with at least one of a tetrazolium or formazan complex that reacts to the presence of ultraviolet light. The tetrazolium or formazan complex is mixed as an indicator composition comprised of the tetrazolium or formazan compound, solvents, a binder, and an optional additive that controls the timing of the color change. The composition can be applied to a substrate. In some embodiments, the formulation is kept in liquid form and can be used to coat a surface of interest, while in other embodiments the formulation is dried to create a chemical indicator.

In other embodiments the chemical indicator is a coated laminate to provide additional protection. More particularly, the claimed indicator can be protected from abrasion and spills through the inclusion of a layer of laminate. Any compatible laminate may be used, for example the laminate may be a polyester and polyethylene blend with a thickness of 1.2 mil, 1.3 mil, 1.4 mil, 1.5 mil, 3 mil, 5 mil or 10 mil. Alternatively, the laminate may be a polypropylene or nylon film with the same thickness. These types of films are available from Ledco, Inc. (Hacienda Heights, Calif.). In addition to laminating films, spray laminates may be used. Examples include, but are not limited to, polyurethane sprays that do not use solvents that can interfere with the tetrazolium/formazan complexes, or any of the additives, such as those available from Rust-Oleum (Vernon Hills, Ill.).

Suitable classes of reactive compounds include tetrazolium salts and formazans that are tri-substituted with phenyl groups. The tetrazolium salt begins clear but it turns a bright yellow color upon exposure to ultraviolet radiation. The formazan compounds begin with a bright red color that turns colorless or yellow upon exposure to ultraviolet radiation. The compounds may, further, react with strong acids to form complexes that are very brightly colored, usually with a yellow hue, when exposed to ultraviolet radiation. The tetrazolium salt compounds contained in the present formulations are members of the class of compounds that have the following general structure:

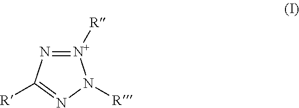

Wherein R′, R″, and R′″ represent aromatic groups. The groups may be the same or different, but are preferably the same. The aromatic groups may be substituted or unsubstituted, but are preferably phenyl groups. The compound also contains a counterion, X⁻, which may be any anion, but which is preferably Cl⁻.

In addition to tetrazolium salts, rormazan dyes formed by the reduction of tetrazolium salts can be contained in the present formulations. The formazan dyes used in the invention are members of the class of compounds that have the following general structure:

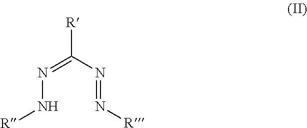

wherein R′, R″, and R′″ represent aromatic groups. The groups may be the same or different, but are preferably the same. The aromatic groups may be substituted or unsubstituted, but are preferably phenyl groups.

The mechanism for the reaction of the tetrazolium or formazan compound upon exposure to ultraviolet radiation depends upon the components used in the mixture. Ebraheem et al. (Ebraheem, S, Abdel-Fattah, A A, Said, F I & Ali, Z I, “Polymer based triphenyl tetrazolium chloride films for ultraviolet radiation monitoring”, Rad. Phys. Chem., vol. 57, pp. 195-202. 2000) created ultraviolet sensitive thin films using 2,3,5-tetrazolium chloride and polyvinylbutyral or polyvinylalcohol. This work shows prior art where 2,3,5-tetrazolium chloride is reduced to a pink triphenyl formazan compound through a free radical intermediate based radiolytic reduction. The films change color from colorless to pink; however, they undergo a small degree of reversion back to colorless after exposure to UV radiation. The film will also revert when held at elevated temperatures. In order to use this type of approach, the film must be calibrated by determining the initial absorbance spectrum of the film, then, after exposure to ultraviolet radiation, a new spectrum is taken and then compared with the initial recording. Another limitation of the previous approach is that the thin film is restricted to radiation doses between 0.04 and 1.5 J/cm², where the typical dose can range into the hundreds of J/cm². Another limitation of this approach is that the performance of the film is negatively affected by high humidity (Basfar, A. A., Rabaeh, K. A., Moussa, A. A., Msalam, R. I. “Dosimetry characterization of nitro-blue tetrazolium polyvinyl butyral films for radiation processing”, Radiation Physics and Chemistry, 80, 763-766, 2011).

The formulation, article of manufacture and methods described and claimed herein advance the art by providing a stable formulation that is not sensitive to high humidity or temperature. The present formulation is also designed so that its performance is flexible. The invention allows the color change reaction to be sped up or slowed down so that the invention may be used for a variety of different purposes. The invention as described also enhances the stability of the formulation and protects its performance against sensitivity to local humidity and temperature. The current invention also advances the art by monitoring total exposure, including exposure that may occur over several exposure periods, and, unlike the previous art, the current invention can be used to monitor typical doses of radiation in the hundreds of J/cm². The lack of reversion of the indicator formula means that the ink will show the difference between a two-hour period in which the exposure was constant, and a two-hour period in which the exposure was lost for 20 minutes due to a power failure.

The present formulation can also be designed to respond to different wavelengths of UV (for example, the formula may respond to UVC radiation only). The distinct color change of the formulations also allows for quick visual determinations of whether the end point color has been reached or not. The examples of the previous art utilize a transition from colorless to colored; this transition is imprecise as the previous art undergoes color reversion once the UV source is removed, and a measurement with a spectrophotometer or other means of measuring color density is required before any degree of reversion can occur.

By careful selection of a polymeric binder and dye mordant (a protic acid), the reaction can be protected against reversion. There are two means of protecting the present formulation against reversion or loss of sensitivity; one is a reduction of the azo groups of the tetrazolium or formazan compound of the formulation. The tetrazolium/formazan compound can be reduced to a yellow form through the presence of hydrogen donors such as additional acids or polymeric binders, such as cellulose, that may donate protons or alkyl groups. A sample mechanism for the reduction of tetrazolium is shown below:

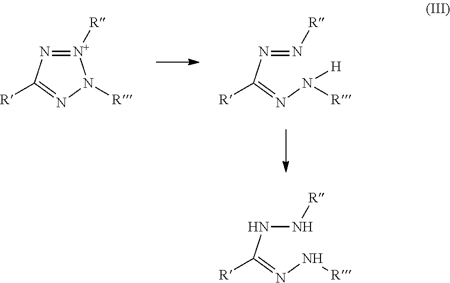

Further reduction may occur depending upon the strength and concentration of the acid. As can be seen above, the acid induced tetrazolium mechanism proceeds through a formazan intermediate. Therefore, it is expected that a tetrazolium compound and a formazan compound with the same substitute R′, R″, and R′″ groups would show the same color after exposure to UV. This does indeed occur, as examples of the present formulation that contain either triphenyl tetrazolium or triphenylformazan and an acid both exhibit a bright yellow color upon exposure to ultraviolet radiation. The existence of the formazan intermediate is also demonstrated as the triphenyl tetrazolium compound undergoes a transition to a pink color before proceeding to the final yellow end point.

In an alternate embodiment, the tetrazolium/formazan compound can be broken down through a radical induced photochemical reaction. This can be accomplished using chemicals that freely form radicals, such as hydrogen peroxide. Radicals can also be obtained by chemicals that undergo photolysis, such as sodium oxalate (Choi, H. J., Choi, J. D., Kim, H. K., Lee, T. J., “Kinetics of Atrazine Oxidation by UV Radiation and Oxalate Assisted H₂O₂/UV Processes”, Environ. Eng. Res., 11, 28-32 2006)). An exemplary mechanism for the photochemical degradation of formazan through the use of radicals is shown below:

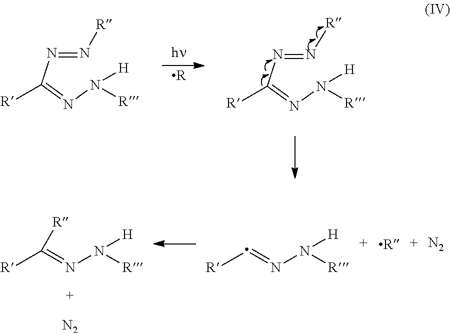

With this approach, the tetrazolium compound does not form a formazan intermediate, and thus one skilled in the art would not expect the triphenyl tetrazolium and formazan based embodiments to have the same end point color. As expected, in the presence of a radical forming species the triphenyl tetrazolium compound turns a light yellow while the formazan compound turns light gray upon exposure to ultraviolet radiation.

The formulations described and claimed herein also include a binder. The binder may be any polymer that binds the formulation to the substrate on which it is printed. Examples of suitable polymers include but are not limited to ethyl cellulose, polystyrenic resins such as Joncryl® HPD 71-E from BASF, polyacrylates, polyvinyl chloride (which is available from Sigma Aldrich), and phenol formaldehyde resins such as BKUA 2370 from Georgia-Pacific or similar. The preferred binders are ethyl cellulose such as T200 from Hercules and polyacrylates such as 6MKK0402725 from CRI International.

A solvent is also included to dissolve the ink components. Examples of suitable solvents include, but are not limited to, aliphatic alcohols, methylated spirits, glycols, water, ethers, esters, ketones, alkanes, sulfoxides and amines or similar. The preferred solvents are methanol, ethanol, propanol, n-butanol, 2-ethyl-1-hexanol, cellosolve acetate(2-ethoxyethylacetate), dimethylsulfoxide, naptha, glycerine, water, 1-methoxy-2-propanol, isopropyl acetate, ethanolamine, tetrahydrofuran and acetone.

Additional additives may be included in order to adjust the timing of the color change that the indicator undergoes when exposed to ultraviolet radiation. Acidic controlling compounds may be optionally added to the tetrazolium salt/formazan mixture in order to control the speed at which the color change occurs. The controlling compounds act as proton donors and are soluble in alcohols or water. Non-limiting examples of such additives include organic acids such as ascorbic acid, dihydroxybenzoic acid, tannic acid, gallic acid, hydroquinone, citric acid, ethylenediaminetetraacetic acid or phloroglucinol carboxylic acid. In addition to decelerating the color change, these acids serve as mordants and can enhance the brightness of the indicator end point color. Mineral acids, such as phosphoric acid, may also be used. Also, careful selection of the binder allows it to serve as the acidic controlling compound as well. Examples of suitable binders are acrylic acids and celluloses. Specific non-limiting examples are polymethacrylic acid (available as Amberlite CG50 from Rohm and Haas) and methyl cellulose (available from Sigma Aldrich).

Non-reactive dyes may be added to the formulation to enhance the distinction between its initial and endpoint color. In particular, tetrazolium salts may begin in a colorless or nearly colorless state. The addition of a small amount of non-reactive dye may allow for a wide variety of initial color shades without negatively impacting the bright yellow or clear endpoint colors. Suitable dyes may be soluble in water or organic solvents. These dyes may be printed in an initial coat located under the reactive ink or prepared with the reactive ink mixture. Non-limiting examples of the non-reactive dyes are Methyl Violet, Orasol B, or any number of Spectrosol dyes. Examples of Spectrosol dyes, available from Spectra Colors Corp., are Yellow R, Yellow G, Brilliant Blue GN, or Brilliant Blue R.

Substrates that the present formulations can be printed on in order to form the articles according to the invention may be skin, hair, fingernails, stone, wood, paper, plastics, laminate, resin, metal, shellac, fibers, leather, fabric, glass, polymers and combinations thereof. The printed substrates may be coated with one or more layers, as noted above, to form a laminate. Examples of suitable laminates contain polyester/polyethylene, polypropylene or nylon and have a thickness between 1.2 and 10 mil. The substrate can be of varying porosity (including non-porous) and the indicator formulation may be coated on the surface or impregnated into the substrate. In some embodiments a single substrate can be printed on with multiple inks, or combinations of materials may be used within a substrate.

The present formulations may also be printed on a substrate that has an adhesive backing. This allows for easier application of the UV chemical indicator, and also allows the indicator to be removable. The adhesive material may be strong enough to be permanent or it may be weak enough to be removable so that the UV chemical indicator can be reapplied or applied in a different area (such as being moved to a notebook for storage and record keeping purposes).

The preparation of the chemical UV indicator involves printing a liquid ink complex containing the reactive tetrazolium salt or formazan compound onto a substrate. The ink is then dried on the substrate. After drying, a laminate spray or film can optionally be applied. The components of the indicator formulation may be added in any order. Drying consists of placing the wetted substrate into an oven or drier at an elevated temperature in order to evaporate the solvent. It is also possible, but not preferable, to allow the wetted substrate to dry at room temperature.

The preferred formulations may in certain embodiments be prepared with just the tetrazolium or formazan compound in concentrations below 5%, between 2% and 50% binder and 50 to 96% solvent. The binder and solvent ratio depend upon the printing method desired. Flexographic prints require high solvent and lower binder concentrations in order to have a smooth print, while screen prints utilize higher binder and lower solvent concentrations in order to prevent the ink from bleeding through the screen mesh during printing. Formulations utilizing just the formazan/tetrazolium compound are limited however; the tetrazolium based formula will undergo a color change to pink that reverts to the original clear color upon removal from the ultraviolet source, while the formazan compound undergoes a color change that is minor (red to light red). Increasing the concentration of the formazan/tetrazolium compound will cause the length of exposure required to cause the color change to increase; this can be used to make slight adjustments to the length of time required for the invention to change from its initial color to the end point color. Significantly changing the required length of exposure (which is necessary for modifying the invention for different applications) requires additional components.

The chemical UV indicator can be improved by adding materials that undergo a radical based photolysis. The additional radicals speed up the radical induced photochemical reaction of the formazan/tetrazolium compound. Adding chemicals that will undergo photolysis in a preferred ratio between 0.1% and 10% to the above-described indicator will accelerate the color change of the tetrazolium/formazan compound. Suitable examples include hydrogen peroxide or sodium oxalate. Any concentrations greater than 10% reduce the storage life of the unprinted formulation and are therefore undesirable. For this invention, the tetrazolium-based mixture will undergo a color change from clear to bright yellow in under 5 minutes. This type of quick reaction is useful for UV curing applications that do not require extended exposure. Examples include UV curing of nail polish, wound treatment or UV curing of paints/inks.

The indicator can also be modified by adding proton donors in the form of acids or binders with proton donating groups. The acids cause a reduction of the azo groups of the tetrazolium and formazan compounds. The acids also cause the tetrazolium compound to convert to a formazan during the reaction. Adding proton-donating compounds in preferred ratios between 0.1% and 10% will decelerate the color change while producing an extremely bright end point color. Suitable non-limiting examples include 2,4-dihydroxybenzoic acid, phluoroglucinol carboxylic acid, hydroquinone, citric acid, phosphoric acid, cellulose, ethylenediaminetetraacetic acid, and ascorbic acid. Any concentrations above 10% may reduce the storage life of the unprinted formulation. Proton-donating binders, such as polymethacrylic acid, should be used in ratios between 2% and 50% as concentrations above 50% can reduce the storage life of the unprinted formulations. For this invention, the tetrazolium and formazan based mixtures will undergo a color change from colorless (tetrazolium) or red (formazan) to a bright yellow in exposure intervals upwards of one hour. This long exposure time is desirable for applications that make use of extended exposures such as tanning, disinfection/sterilization of microbial life, routine monitoring of UV producing equipment such as fluorescent lamps or air purifiers.

The requirements for modifying the present formulations can be described as follows. For an indicator that will change color after a short (5 minutes of less) interval of exposure, add a component that will form radicals upon exposure to ultraviolet radiation to a formazan/tetrazolium mixture. For an indicator that will change color after prolonged exposure to ultraviolet radiation, add a protonic acid to a formazan/tetrazolium mixture; tetrazolium based mixtures will have even longer exposure times than formazan based formulations. For small changes in the required exposure times, modify the concentrations of the formazan/tetrazolium compounds, wherein higher concentrations lead to a longer required length of exposure before obtaining the color change to the end point color.

The chemical UV indicators described and claimed herein can be used to evaluate the exposure to ultraviolet radiation. The indicators may be used to determine if the exposure to UV radiation over time meets an exposure threshold, or a single indicator can be used over several exposure periods until a desired exposure threshold is met. The indicator may also be relied upon to stop UV exposure once a desired threshold is reached. Also, in certain ones of the present formulations, the formulation can differentiate between high and low wavelength UV. In systems were a specific wavelength is expected, for instance in exposure for UV sterilization or disinfection, the chemical indicators can monitor and verify the time period of exposure to this specific type of radiation. In applications where semi-quantitative monitoring is important, for example when being exposed to sunlight during a sporting event, a chemical indicator can be used to monitor total exposure to ultraviolet radiation. The indicators may be used until the endpoint color is reached in a single exposure to signal an end to that exposure period, or a single indicator may be used over several exposure intervals until the endpoint is reached. In the preferred embodiment, the indicator is evaluated by visual examination; however, if more precision is required the indicator may be evaluated using a spectrophotometer to enumerate the color densities of the chemical indicators. The indicator may also be compared to a control that shows the initial color and expected endpoint color after exposure to UV radiation.

The chemical UV indicator can also be applied in such a way as to evaluate topical UV exposure. That is, the indicator can evaluate the exposure of a specific surface or part of the body to ultraviolet radiation. The indicator may be applied, for example, as a gel, cream or lotion to a surface or to the skin. The indicator will undergo a color change, indicating exposure, and then it may be removed by washing or scrubbing.

The chemical UV indicator and ultraviolet reactive formulation of this invention are advantageous in that they undergo a controlled, distinct color change when exposed to ultraviolet radiation. They may be less costly than known inventions, and the indicators may be made small enough that they can be used in difficult to reach locations. They also offer stable records that may be kept and examined long after the period of radiation exposure. The ink undergoes a color change to a distinct end point color. Any exposure beyond the end point color will not result in any additional color change. Any indicator not reaching the end point can be kept as an indicator that the exposure was less than what the indicator was designed for. Any indicator that does reach the end point color can be kept as a record that the exposure conditions were indeed met.

The chemical UV indicator of this invention is also advantageous in that it can be modified to produce color changes that are based on skin type. For example, individuals with fair skin color, or children, would benefit from an indicator that reacts very quickly in sunlight; however, such an indicator may react too quickly for a dark skinned person. The indicator described and claimed herein can be modified and slowed down so that a different, more slowly reacting, version can be used. Alternatively, individuals with a family history of skin cancer may desire a very fast reacting version of the chemical indicator and this desire can be readily accommodated by the current invention.

### EXAMPLES

The invention will now be illustrated using several non-limiting examples. Further examples may be apparent to those skilled in the art after examination of the following.

### Color Change Description

It is well established that a chemical indicator undergoes a color transition from a defined initial color to a specific endpoint color. For example, as described in ISO 11140-1 (ISO 11140-1:2005 Sterilization of Health Care Products—Chemical Indicators—Part 1: General Requirements), an endpoint color is the point of the observed color change occurring after the indicator has been exposed to the factors or conditions specified by the manufacturer. This color change is defined as one of three transitions: from “light to dark”, from “dark to light”, or from one color to a “distinctly different color”. As stated in the FDA chemical indicator guidance document for industry and staff “there should be a high visual contrast between the initial and endpoint appearance” (Premarket Notification [510(k)] Submissions for Chemical Indicators: Guidance for Industry and FDA Staff. 2003).

### Color Change Using the CIE L*a*b* System

Colors are typically described in industry using a coordinate system called CIE L*a*b* ISO 11664-4:2008/CIE S 014-4/E:2007: 1976 L*a*b* Colour Space, where L*, a*, and b* are three parameters that describe colors. The system is useful because measurements in CIE L*a*b* space are device-independent. In this application, device-independent means that the color description in L*a*b* space remains constant regardless of the machine used to record the measurement. In this system, as described by A. Hanbury and J. Serra, Mathematical Morphology in the CIELAB Space, Image Analysis and Stereology, Vol. 21, No. 3, pages 201-206, 2002, grey or colorless spots are located on the lightness axis (where a* and b* both equal 0) such that black is at L*=0 and white is at L*=100*, a* represents the position between green (negative values) and red (positive), and b* represents the position between blue (negative) and yellow (positive). The quantity ΔE represents the absolute difference between two sets of color measurements, and is equal to the square root of (L₁*−L₂*)²+(a₁*−a₂*)²+(b₁*−b₂*). Two colors that have a ΔE less than one when compared will appear identical to the typical human observer. The CIEL*a*b* system is used here as an objective reference to confirm visual evaluation. The use of the CIEL*a*b* system with this invention is not a requirement, however. The CIEL*a*b* system is simply a means of quantifying colors for direct comparison and allows a numerical comparison of colors and color changes. The invention can and should be used without the CIEL*a*b* system as the color changes are dramatic enough to be easily seen without any color measurement devices.

When using the typical bright white paper substrate, the transition between color and colorless is usually associated with small changes on the three axes (L*, a*, and b*) of the CIEL*a*b* coordinate system. When compared to a color change between two distinct colors printed on the bright white paper substrate the transition between two distinct colors will demonstrate a larger ΔE value, which indicates that the color change between two distinct colors is easier for the human eye to recognize.

For these examples, the color change from the initial color to the end point color was determined visually and by a ColorEye XTH (available from X-Rite, Inc., Grand Rapids, Mich.) spectrophotometer using CIEL*a*b* space. The spectrophotometer was set to a D65 illuminant and a 10 degree observer for all of the recorded measurements. The difference between the initial and end point colors is represented by a quantity called ΔE, and the scale is such that the average human eye cannot distinguish colors with a ΔE that is less than 1. The higher the ΔE value, the larger the visual difference between two colors. The results obtained with the various examples are tabulated in Table 1 below.

The first three examples illustrate how the additives can be used to control the rate of color change or to enhance the end point color by making it brighter or more distinctive.

### Example 1

| Ingredient | Weight (g) |
|---|---|
| 1,3,5-Triphenyltetrazolium Formazan | 0.15 |
| Cellosolve Acetate | 25 |
| n-Propanol | 25 |
| Ethanol | 25 |
| Methyl Cellulose | 3.5 |

Upon exposure to UVA radiation, the indicator was found to react very strongly and changed from a bright red color to a dull yellow end point color. Upon exposure to UVB and UVC radiation the indicator remained red. The color change was evaluated using a spectrophotometer and ΔE was found to be less than 5 for one hour exposure to 254 nm radiation (18 J/cm² dose), 5 for two hours exposure to 302 nm radiation (36 J/cm² dose), and 55 for 30 minute exposure to 370 nm radiation (9 J/cm² dose). This is an example of a formulation that is selective and will only change when exposed to longer wavelength ultraviolet radiation.

### Example 2

| Ingredient | Weight (g) |
|---|---|
| 1,3,5-Triphenyltetrazolium Formazan | 0.15 |
| Cellosolve Acetate | 25 |
| n-Propanol | 25 |
| Phloroglucinol Carboxylic Acid | 2 |
| Ethanol | 25 |
| Methyl Cellulose | 3.5 |

Upon exposure to UVA radiation, the indicator was found to react very strongly and changed from a bright red color to a bright yellow end point. The addition of phloroglucinol carboxylic acid served to enhance the color difference between exposed and unexposed samples, while decelerating the color change. The reaction took longer than that of example 1 to reach the endpoint, but the endpoint color change was much more pronounced. Upon exposure to UVB and UVC radiation the indicator turned yellow. The ΔE was approximately 40 for two hours exposure to 254 nm radiation (36 J/cm² dose), 30 for 150 minutes exposure to 302 nm radiation (45 J/cm² dose), and 50 for 40 minute exposure to 370 nm radiation (12 J/cm² dose). This type of indicator would be useful exposure of dark skin tones to a tanning bed.

### Example 3

| Ingredient | Weight (g) |
|---|---|
| 1,3,5-Triphenyltetrazolium Formazan | 0.15 |
| Cellosolve | 30 |
| n-Propanol | 20 |
| Sodium Oxalate | 2 |
| Ethanol | 20 |
| Polyvinylchloride | 10 |

Upon exposure to UVA, UVB and UVC radiation, the indicator was found to react very strongly and changed from red to a gray end point. The sodium oxalate was added to enhance the endpoint color and to dramatically increase the rate of color change. The ΔE was approximately 55 for 30 minutes exposure to 254 nm radiation (9 J/cm² dose), 40 for 25 minutes exposure to 302 nm radiation (9 J/cm² dose), and 40 for 30 minute exposure to 370 nm radiation (9 J/cm² dose). This color change and wavelength selectivity would be desirable for use as an indicator of exposure to the type of ultraviolet radiation used to eradicate MRSA.

### Example 4

| Ingredient | Weight (g) |
|---|---|
| 2,3,5-Triphenyltetrazolium Chloride | 1 |
| Cellosolve | 30 |
| n-Propanol | 20 |
| Ethanol | 20 |
| Polymethacrylic acid | 5 |

The indicator reacted on exposure to UVA, UVB and UVC radiation and changed from clear to a light yellow end point. The ΔE was approximately 20 for 3 hours exposure to 254 nm radiation (54 J/cm² dose), 20 for 8 hours exposure to 302 nm radiation (144 J/cm² dose), and 20 for 4 hours exposure to 370 nm radiation (72 J/cm² dose). This type of slow change would be useful for evaluating total exposure over prolonged intervals or when spending time outside in sunlight.

### Example 5

| Ingredient | Weight (g) |
|---|---|
| 2,3,5-Triphenyltetrazolium Chloride | 1 |
| 2,4-Dihydroxybenzoic Acid | 2 |
| Cellosolve | 25 |
| n-Propanol | 25 |
| Ethanol | 25 |
| Polymethacrylate | 10 |

The addition of acid slowed the indicator color change reaction time as compared with the results of Example 4; however, the end point color was a brighter shade of yellow when exposed to UVA, UVB, or UVC radiation and was therefore more noticeable. The color change was evaluated using a spectrophotometer and the ΔE was found to be approximately 30 after 8 hours of exposure to 370 nm UV radiation, and around 30 after 8 hours of exposure to 254 nm radiation. The ΔE was approximately 30 for 8 hours exposure to 254 nm radiation (144 J/cm² dose), 30 for 12 hours exposure to 370 nm radiation (216 J/cm² dose), and 30 for 8 hours exposure to 370 nm radiation (144 J/cm² dose).

### Example 6

| Ingredient | Weight (g) |
|---|---|
| 2,3,5-Triphenyltetrazolium Chloride | 1 |
| Hydrogen Peroxide | 0.25 |
| n-Propanol | 20 |
| Cellosolve Acetate | 20 |
| Ethanol | 20 |
| Polyvinylchloride | 10 |

The use of a radical source greatly quickened the color change of the invention. For this example, the color changed from clear to yellow. When exposed to UVA, UVB, or UVC radiation. The ΔE was approximately 40 for 5 minutes exposure to 254 nm radiation (1.5 J/cm² dose), 40 for 5 minutes exposure to 302 nm radiation (1.5 J/cm² dose), and 35 for 3 minutes exposure to 370 nm radiation (0.9 J/cm² dose). This type of quick reacting invention would be useful for UV curing of nail polish, direct wound treatment or any other applications in which human exposure may occur but should be minimized and monitored.

### Example 7

| Ingredient | Weight (g) |
|---|---|
| 2,3,5-Triphenyltetrazolium Chloride | 0.5 |
| Spectrosol Brilliant Blue GN | 0.05 |
| Cellosolve Acetate | 35 |
| Ethanol | 35 |
| Polymethacrylic acid | 5 |

The color change response to that was similar for all three types of UV exposure in a transition from blue to light yellow/green. The ΔE was approximately 10 for 1 hour exposure to 254 nm radiation (18 J/cm² dose), 15 for 20 minutes exposure to 302 nm radiation (6 J/cm² dose), and 15 for 20 minutes exposure to 370 nm radiation (6 J/cm² dose). When exposed to sunlight, the ΔE was found to be approximately 15 after 20 minutes of exposure.

### Example 8

| Ingredient | Weight (g) |
|---|---|
| 2,3,5-Triphenyltetrazolium Chloride | 1 |
| Spectrosol Brilliant Blue GN | 0.05 |
| Cellosolve Acetate | 35 |
| Ethanol | 35 |
| Polymethacrylic acid | 5 |

Similar for UVB and UVC radiation, where the endpoint was green; the endpoint upon exposure to UVA radiation exhibited a bright yellow-green color. The ΔE was approximately 20 for 2 hours exposure to 254 nm radiation (36 J/cm² dose), 20 for 40 minutes exposure to 302 nm radiation (12 J/cm² dose), and 25 for 30 minutes exposure to 370 nm radiation (9 J/cm² dose). When exposed to sunlight; the ΔE was found to be approximately 25 after 40 minutes of exposure. The color change requires additional exposure time and results in a slightly more pronounced color change than example 7 because of the increase in tetrazolium concentration.

### Example 9

| Ingredient | Weight (g) |
|---|---|
| 1,3,5-Triphenyltetrazolium Formazan | 0.2 |
| Spectrosol Yellow R | 0.05 |
| Cellosolve Acetate | 35 |
| Ethanol | 35 |
| Polymethacrylic acid | 5 |

The ΔE was approximately 10 for 2 hours exposure to 254 nm radiation (36 J/cm² dose), 5 for 2 hours exposure to 302 nm radiation (36 J/cm² dose), and 40 for 30 minutes exposure to 370 nm radiation (9 J/cm² dose). When exposed to sunlight, the color changed from orange to yellow and ΔE was found to be approximately 40 after 20 minutes of exposure. The indicator turned a light orange color when exposed to UVC or UVB radiation and a yellow color when exposed to UVA radiation.

### Example 10

| Ingredient | Weight (g) |
|---|---|
| 1,3,5-Triphenyltetrazolium Formazan | 0.4 |
| Spectrosol Yellow R | 0.05 |
| Cellosolve Acetate | 35 |
| Ethanol | 35 |
| Polymethacrylic acid | 5 |

The ΔE was approximately 10 for 2 hours exposure to 254 nm radiation (36 J/cm² dose), 10 for 2 hours exposure to 302 nm radiation (36 J/cm² dose), and 50 for 45 minutes exposure to 370 nm radiation (13.5 J/cm² dose). When exposed to sunlight, the color changed from red to yellow and the ΔE was found to be approximately 45 after 40 minutes of exposure. The color change requires additional exposure time and results in a slightly more pronounced color change than example 9 because of the increase in formazan concentration. When exposed to UVB and UVC radiation, the indicator turned an orange color, and when exposed to UVA radiation the indicator turned a yellow color.

### Example 11

| Ingredient | Weight (g) |
|---|---|
| 2,3,5-Triphenyltetrazolium Chloride | 1.5 |
| 1,3,5-Triphenyltetrazolium Formazan | 0.25 |
| 2,4-Dihydroxybenzoic Acid | 1 |
| Cellosolve Acetate | 60 |
| Sodium Oxalate | 1 |
| Polymethacrylate | 10 |

The indicator began with a red color. After exposure to UVC radiation, the indicator changed to a light orange color, and after exposure to UVB radiation, the indicator turned a light orange-yellow color, and after exposure to UVA radiation, the indicator turned a yellow color. The ΔE was approximately 10 for 8 hours exposure to 254 nm radiation (144 J/cm² dose), 25 for 40 minutes exposure to 302 nm radiation (12 J/cm² dose), and 35 for 40 minutes exposure to 370 nm radiation (12 J/cm² dose).

### Example 12

| Ingredient | Weight (g) |
|---|---|
| 2,3,5-Triphenyltetrazolium Chloride | 1.5 |
| 1,3,5-Triphenyltetrazolium Formazan | 0.25 |
| Spectrosol Brilliant Blue GN | 0.1 |
| 2,4-Dihydroxybenzoic Acid | 1 |
| Cellosolve Acetate | 60 |
| Sodium Oxalate | 1 |
| Polymethacrylate | 10 |

The indicator started out purple. After exposure to UVC radiation, the indicator changed to pink, after exposure to UVB radiation, the indicator turned green, and after exposure to UVA radiation, the indicator turned a yellow color. The ΔE was approximately 15 for 8 hours exposure to 254 nm radiation (144 J/cm² dose), 30 for 40 minutes exposure to 302 nm radiation (12 J/cm² dose), and 60 for 40 minutes exposure to 370 nm radiation (12 J/cm² dose).

The color changes of the examples are summarized in Table 1.

| | | 254 nm End | 302 nm End | 370 nm End | Sunlight End |
|---|---|---|---|---|---|
| Example | Initial Color | Point | Point | Point | Point |
| 1 | Red | Light Red | Light Red | Dull Yellow | Light Grey |
| 2 | Red | Yellow | Yellow | Yellow | Bright Yellow |
| 3 | Red | Gray | Gray | Gray | Gray |
| 4 | Clear | Light Yellow | Yellow | Yellow | Yellow |
| 5 | Clear | Yellow | Yellow | Yellow | Yellow |
| 6 | Clear | Yellow | Yellow | Yellow | Yellow |
| 7 | Blue | Light Yellow- | Light Yellow- | Light Yellow- | Light Yellow- |
| | | Green | Green | Green | Green |
| 8 | Blue | Light Yellow- | Light Yellow- | Yellow-Green | Yellow-Green |
| | | Green | Green | | |
| 9 | Orange | Light Orange | Light Orange | Yellow | Yellow |
| 10 | Red | Orange | Light Yellow | Yellow | Yellow |
| 11 | Red | Light Orange | Orange-Yellow | Yellow | Yellow |
| 12 | Purple | Pink | Green | Yellow | Yellow |

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A formulation for evaluating exposure of a surface to ultraviolet (UV) radiation, said formulation comprising:
a) at least one material selected from the group consisting of tetrazolium compounds and formazan compounds, said compounds reacting in the presence of ultraviolet light, said reaction being evidenced by (i) an irreversible color change of said at least one material from a first color to a second color, said second color being one selected from the group consisting of a shade of said first color that is perceptibly darker than said first color, a shade of said first color that is perceptibly lighter than said second color and a distinctly different color than said first color, or (ii) by an irreversible change from a colored state to a substantially colorless state or vice versa;
b) a polymeric binder that binds the formulation to a substrate;
c) a solvent that solubilizes solid components of said formulation; and
d) an additive comprising at least one of a proton donating compound and a compound that will undergo photolysis in the presence of ultraviolet light to generate free radicals, said additive stabilizing the color change of said at least one material by preventing reversion from said second color to said first color or from the substantially colorless state back to the colored state.

2. The formulation according to claim 1, wherein the tetrazolium compound comprises a tetrazolium salt having the general formula: 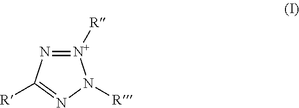
wherein R′, R″ and R′″ are each aromatic groups, which aromatic groups are the same or different from one another, and wherein the aromatic groups are substituted or unsubstituted.

3. The formulation according to claim 2, wherein the aromatic groups are all the same.

4. The formulation according to claim 2, wherein at least one of the aromatic groups is a phenyl group.

5. The formulation according to claim 2, wherein the tetrazolium compound further comprises an anion (X⁻), wherein the anion may be any anion.

6. The formulation according to claim 5, wherein the anion is Cl⁻.

7. The formulation according to claim 1, wherein the formazan compound comprises a formazan dye having the general formula: 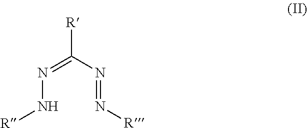
wherein R′, R″ and R′″ are each aromatic groups, which aromatic groups are all the same or different from one another, and wherein the aromatic groups are substituted or unsubstituted.

8. The formulation according to claim 7, wherein the aromatic groups are all the same.

9. The formulation according to claim 7, wherein at least one of the aromatic groups is a phenyl group.

10. The formulation according to claim 1, wherein the tetrazolium compound is selected from the group consisting of:
2,3,5-triphenyltetrazolium chloride;
2-(2-methylphenyl)-3,5-diphenyl-2H-tetrazolium tetrafluoroborate;
2-(4-chlorophenyl)-3,5-diphenyl-2H-tetrazolium tetrafluoroborate;
2,3-diphenyl-5-(4-chlorophenyl)-2H-tetrazolium tetrafluoroborate;
2-(4-iodophenyl)-3,5-diphenyl-2H-tetrazolium tetrafluoroborate;
2-(4-chlorophenyl)-3-(2-chlorophenyl)-5-(2-pyridyl)-2H-tetrazolium iodide;
2,3-diphenyl-2H-tetrazolium sulfate;
2-(2-methoxyphenyl)-3,5-diphenyl-2H-tetrazolium tetrafluoroborate;
2,3-diphenyl-5-methyl-2H-tetrazolium chloride;
2,3-diphenyl-5-dodecyl-2H-tetrazolium chloride;
5-(3-iodophenyl)-2,3-diphenyl-2H-tetrazolium chloride;
5-cyano-2,3-diphenyl-2H-tetrazolium chloride;
5-acetyl-2,3-diphenyl-2H-tetrazolium chloride;
2,5-diphenyl-3-(4-tolyl)-2H-tetrazolium bromide;
2,5-diphenyl-3-(4-biphenylyl)2H-tetrazolium chloride;
2,3-diphenyl-5-(2-chlorophenyl)-2H-tetrazolium iodide;
5-(3,4-dimethoxyphenyl)-3-(4-nitro-phenyl)-2-phenyl-2H-tetrazolium iodide;
2,3-diphenyl-5-nitro-2H-tetrazolium chloride;
2,3-diphenyl-5-(2-naphthyl)-2H-tetra-zolium chloride;
Ethylenebis[5-(2,3-diphenyl-2H-tetrazolium chloride)];
1,6-hexylenebis[5-(2,3-diphenyl-2H-tetrazolium chloride)];
1,4-phenylenebis[5-(2,3-diphenyl-2H-tetrazolium chloride)];
4,4′-biphenylylenebis[2-(5-methyl-3-phenyl-2H-tetrazolium chloride)];
4,4′-phenylene sulfoxide-bis[2-(3,5-diphenyl-2H-tetrazolium chloride)];
4,4′-biphenylylenebis[2-(3-diphenyl-5-(3,4-methylenedioxyphenyl-2H-tetrazolium chloride)];
2-phenyl-3-(4-nitrophenyl)-5-undecyl-2H-tetrazolium chloride;
2,3-diphenyl-5-carbethoxy-2H-tetrazolium chloride;
5-carbohexoxy-2,3-diphenyl-2H-tetrazolium chloride;
5-acetyl-2-phenyl-3-(4-chlorophenyl)-2H-tetrazolium tetrafluoroborate;
2,3-diphenyl-5-(1-naphthyl)-2H-tetrazolium bromide;
2-(2,4,6-trichlorophenyl)-3,5-diphenyl-2H-tetrazolium tetrafluoroborate;
2-(3,4-dichlorophenyl)-3,5-diphenyl-2H-tetrazolium tetrafluoroborate
2,3-diphenyl-5-(3-nitrophenyl)-2H-tetrazolium tetrafluoroborate;
2-(3-nitrophenyl)-3,5-diphenyl-2H-tetrazolium tetrafluoroborate;
2,3-diphenyl-5-(4-nitrophenyl)-2H-tetrazolium tetrafluoroborate
2,5-Diphenyl-3-(α-naphthyl)tetrazolium chloride);
3,3′-(3,3′-Dimethoxy[1,1′-biphenyl]-4,4′-diyl)-bis(2,5-diphenyl-2H-tetrazolium)dichloride;
3-(4,5-Dimethyl-2-thiazolyl)-2,5-diphenyl-2H-tetrazolium bromide;
3,3′-(3,3′-Dimethoxy-4,4′-biphenylene)bis[2,5-bis(p-nitrophenyl)-2H-tetrazolium chloride];
2-(2′-Benzothiazolyl)-5-styryl-3-(4′-phthalhydrazidyl)tetrazolium chloride;
2,2′-Di(p-nitrophenyl)-5,5′-di(p-thiocarbamylphenyl)-3,3′-(3,3′-dimethoxy-4,4′-biphenylene)ditetrazolium chloride;
2,2′-bis(4-Nitrophenyl)-5,5′-diphenyl-3,3′-(3,3′-dimethoxy-4,4′-diphenylene)ditetrazolium chloride;
2-(4-Iodophenyl)-3-(4-nitrophenyl)-5-phenyl-2H-tetrazolium chloride;
2,3-Bis(2-methoxy-4-nitro-5-sulfophenyl)-2H-tetrazolium-5-carboxanilide; and
3,3′-(3,3′-Dimethoxy-4,4′-biphenylene)bis[5-(3-nitrophenyl)-2-phenyl-2H-tetrazolium chloride].

11. The formulation according to claim 1, wherein the formazan compound is selected from the group consisting of:
1,3,5-triphenyltetrazolium formazan;
1-(4,5-Dimethylthiazol-2-yl)-3,5-diphenylformazan;
1-(4-Iodophenyl)-5-(4-nitrophenyl)-3-phenylformazan; and
1-Carbamimidoyl-3-phenyl-5-(1H-tetrazol-5-yl)formazan.

12. The formulation according to claim 1, wherein the formulation is produced in a form selected from the group consisting of a liquid, an ink, a cream, an aerosol, a gel and a paint.

13. The formulation according to claim 1, wherein the proton donor is selected from the group consisting of an acid and a polymeric binder that donates protons.

14. The formulation according to claim 1, wherein the radical-forming material is a species that will form free radicals via photolysis when exposed to ultraviolet radiation.

15. The formulation according to claim 14, wherein the radical-forming material is selected from the group consisting of peroxide, oxalate, nitrate and metallocene.

16. The formulation according to claim 15, wherein the radical-forming material is selected from the group consisting of hydrogen peroxide, benzoyl peroxide, tert-butyl hydroperoxide, dimethyl oxalate, ferrioxalate, sodium oxalate, sodium nitrate and ferrocene.

17. The formulation according to claim 1, wherein the binder additionally protects an endpoint color of said formulation against reversion toward an initial color.

18. The formulation according to claim 1, wherein the binder is selected from the group consisting of acrylates, acrylic acids, celluloses, styrenic resins, phenol formaldehyde resins and plastics.

19. The formulation according to claim 1, wherein the binder is selected from the group consisting of polymethacrylic acid, methyl cellulose, ethyl cellulose, polymethacrylate, polystyrene resins, polyvinyl chloride and phenolic resins.

20. The formulation according to claim 1, wherein the solvent is selected from the group consisting of an aliphatic alcohol, a methylated spirit, a glycol, water, an ether, an ester, a ketone, an alkane, a sulfoxide and an amine.

21. The formulation according to claim 1, wherein the solvent is selected from the group consisting of methanol, ethanol, propanol, butanol, 2-ethyl-1-hexanol, cellosolve, cellosolve acetate, dimethylsulfoxide, naptha, glycerine, water, 1-methoxy-2-propanol, isopropyl acetate, ethanolamine, tetrahydrofuran and acetone.

22. The formulation according to claim 1, further comprising an additive that stabilizes the reaction by donating protons to tetrazolium and formazan moieties.

23. The formulation according to claim 22, wherein the acid additive is a protic acid selected from the group consisting of substituted benzoic acids, acetic acids, ascorbic acids, hydroquinones, mineral acids and citric acids.

24. The formulation according to claim 20, wherein the acid is selected from the group consisting of 2,4-dihydroxybenzoic acid, L-ascorbic acid, hydroquinone, citric acid, phosphoric acid and ethylenediaminetetraacetic acid.

25. The formulation according to claim 22 wherein the additive is a proton donating binder selected from the group consisting of polymethacrylic acid and methyl cellulose.

26. The formulation according to claim 22, wherein the acid additive also serves as a mordant that enhances brightness of said second color following the color change by forming a complex with at least one of the formazan and tetrazolium compound.

27. The formulation according to claim 1, further comprising a non-reactive dye that enhances distinction between the first color and the second color, said dye being unreactive to ultraviolet light and pH.

28. The formulation according to claim 22, wherein the non-reactive dye is selected from the group consisting of solvent yellow 162, solvent yellow 25, and solvent blue 49.

29. The formulation according to claim 1, wherein the at least one of a tetrazolium compound and a formazan compound is present in an amount below about 5% by weight, the polymeric binder is present in an amount between about 2%-50% by weight and the solvent is present in an amount between about 50-96% by weight.

30. The formulation according to claim 1, wherein (d) is the radical forming material and said radical-forming material is present in the formulation in an amount between 0.1% and 10% by weight.

31. The formulation according to claim 1, wherein (d) is a proton donor and said proton donor is present in the formulation in an amount between about 0.1% and 10% by weight.

32. A chemical UV indicator comprising the formulation according to claim 1 in a form selected from the group consisting of a liquid, an ink, a cream, an aerosol, a paint and a gel, and wherein the formulation is at least one of printed on a surface of a substrate and impregnated into said substrate.

33. The chemical UV indicator of claim 32, wherein prior to application of said formulation the substrate is provided with at least one layer of a coating material and said formulation is applied to an uppermost one of said at least one coating layer.

34. The chemical UV indicator according to claim 32, wherein the formulation is in the form of an ink and the substrate is printed with multiple inks.

35. The chemical UV indicator according to claim 32, wherein the substrate is formed of a material selected from the group consisting of skin, hair, fingernail, stone, wood, paper, plastic, laminate, resin, metal, shellac, fibers, leather, fabric, glass, polymers and combinations thereof.

36. The chemical UV indicator according to claim 35, wherein the substrate is a clear substrate and wherein the color change is one of a transition from a first colored state to a second, substantially colorless state, a transition between two colored states and a transition from a first, substantially colorless state to a second colored state.

37. The chemical UV indicator according to claim 35, wherein the substrate is a colored substrate, wherein the color change is one of a transition from a first colored state to a second, substantially colorless state, and a transition from a first, substantially colorless state to a second colored state, a transition between two colored states and wherein the color of the substrate may be observed through the substantially colorless material.

38. The chemical UV indicator according to claim 37, wherein the substrate is white in color and wherein the white color of the substrate may be observed through the substantially colorless material.

39. The chemical UV indicator according to claim 32, wherein the indicator is coated on at least one surface thereof with one or more layers forming a laminate upon said substrate.

40. The chemical UV indicator according to claim 39, wherein at least one layer comprising said laminate is formed from a material selected from the group consisting of polyester/polyethylene, polypropylene and nylon.

41. The chemical UV indicator according to claim 39, wherein the laminate has a thickness of between about 1.2 and 10 mil.

42. The chemical UV indicator according to claim 32, wherein the substrate is provided with an adhesive backing to facilitate adherence of the chemical UV indicator to a surface.

43. The chemical UV indicator according to claim 32 wherein, in the formulation, the tetrazolium compound comprises a tetrazolium salt having the general formula: 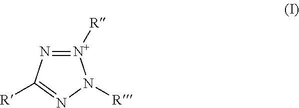
wherein each of R′, R″ and R′″ are aromatic groups, which aromatic groups are all the same or different, and wherein the aromatic groups are substituted or unsubstituted.

44. The chemical UV indicator according to claim 43, wherein the aromatic groups are all the same.

45. The chemical UV indicator according to claim 43, wherein at least one of the aromatic groups is a phenyl group.

46. The chemical UV indicator according to claim 32, wherein the tetrazolium compound further comprises an anion (X⁻), wherein the anion may be any anion.

47. The chemical UV indicator according to claim 32 wherein, in the formulation, wherein the formazan compound comprises a formazan dye having the general formula: 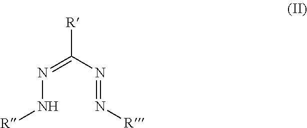
wherein each of R′, R″ and R′″ are aromatic groups, which aromatic groups are all the same or different, and wherein the aromatic groups are substituted or unsubstituted.

48. The chemical UV indicator according to claim 47, wherein the aromatic groups are all the same.

49. The chemical UV indicator according to claim 47, wherein at least one of the aromatic groups is a phenyl group.

50. The chemical UV indicator according to claim 32, wherein the proton donor is selected from the group consisting of an acid and a polymeric binder that donates protons.

51. The chemical UV indicator according to claim 32, wherein the radical-forming material is a species that will form free radicals via photolysis when exposed to ultraviolet radiation.

52. The chemical UV indicator according to claim 32, wherein the binder is selected from the group consisting of acrylates, acrylic acids, celluloses, styrenic resins, phenolic resins and plastics.

53. The chemical UV indicator according to claim 32, wherein the binder is selected from the group consisting of polymethacrylate, polymethacrylic acid, methyl cellulose, ethyl cellulose, polystyrene resins, polyvinyl chloride and phenol formaldehyde resins.

54. The chemical UV indicator according to claim 32, wherein the solvent is selected from the group consisting of an aliphatic alcohol, a methylated spirit, a glycol, water, an ether, an ester, a ketone, an alkane, a sulfoxide and an amine.

55. The chemical UV indicator according to claim 32, wherein the solvent is selected from the group consisting of methanol, ethanol, propanol, butanol, 2-ethyl-1-hexanol, cellosolve, cellosolve acetate, dimethylsulfoxide, naptha, glycerine, water, 1-methoxy-2-propanol, isopropyl acetate, ethanolamine, tetrahydrofuran and acetone.

56. The chemical UV indicator according to claim 32, wherein the formulation further comprises an acid additive that stabilizes the reaction by donating protons to tetrazolium or formazan moieties.

57. The chemical UV indicator according to claim 56, wherein the acid additive is a protic acid selected from the group consisting of substituted benzoic acids, acetic acids, ascorbic acids, hydroquinones, mineral acids and citric acids.

58. The chemical UV indicator according to claim 57, wherein the acid is selected from the group consisting of 2,4-dihydroxybenzoic acid, L-ascorbic acid, hydroquinone, citric acid, phosphoric acid and ethylenediaminetetraacetic acid.

59. The chemical UV indicator according to claim 56 wherein the additive is a proton donating binder selected from the group consisting of polymethacrylic acid and methyl cellulose.

60. The chemical UV indicator according to claim 56, wherein the acid additive also serves as a mordant that enhances brightness of said second color following its color change by forming a complex with at least one of the formazan and tetrazolium compound.

61. The chemical UV indicator according to claim 32, wherein the formulation further comprises a non-reactive dye that enhances distinction between the first color and the second color, said dye being unreactive to ultraviolet light and pH.

62. The chemical UV indicator according to claim 61, wherein the non-reactive dye is selected from the group consisting of solvent yellow 162, solvent yellow 25, and solvent blue 49.

63. The chemical UV indicator according to claim 32, wherein the at least one of a tetrazolium compound and a formazan compound is present in the formulation in an amount below about 5% by wt., the polymeric binder is present in an amount between about 2%-50% by wt. and the solvent is present in an amount between about 50-96% by wt.

64. The chemical UV indicator according to claim 32 wherein, in the formulation, (d) is the radical-forming material and the radical-forming material is present in the formulation in an amount between 0.1% and 10% by weight.

65. The chemical UV indicator according to claim 32 wherein, in the formulation, (d) is a proton donor and said proton donor is present in the formulation in an amount between 0.1 and 10% by weight.

66. A chemical UV indicator for evaluating exposure of a surface to ultraviolet (UV) radiation, said indicator comprising:
a) a formulation in the form of an ultraviolet sensitive liquid, gel, fluid or cream, said formulation comprising at least one material selected from the group consisting of tetrazolium compounds and formazan compounds, said compounds reacting in the presence of ultraviolet light, the reaction being evidenced by (i) an irreversible color change of said at least one material from a first color to a second color, said second color being one selected from the group consisting of a shade of said first color that is perceptibly darker than said first color, a shade of said first color that is perceptibly lighter than said first color; and a distinctly different color than said first color, or (ii) by an irreversible change from a colored state to a substantially colorless state and vice versa; and
b) a substrate, wherein the formulation is at least one of printed on a surface of the substrate and impregnated into said substrate,
and wherein the formulation further comprises
(i) a polymeric binder that binds the formulation to the substrate;
(ii) a solvent that solubilizes solid components of the formulation; and
(iii) an additive comprising at least one of a proton donating compound
and a compound that will undergo photolysis in the presence of ultraviolet light in order to generate free radicals, said additive stabilizing the color change of said at least one material by preventing reversion from said second color to said first color, or from the substantially colorless state to the colored state

67. The chemical UV indicator according to claim 66, wherein the formulation further comprises:
(iv) an acid additive that stabilizes the reaction by donating protons to tetrazolium or formazan moieties.

68. The chemical UV indicator according to claim 66, wherein the formulation further comprises:
(v) a non-reactive dye that enhances distinction between the first color and the second color, said dye being unreactive to ultraviolet light and pH.

69. The chemical UV indicator according to claim 66, wherein the formulation is in the form of an ink and the substrate is printed with multiple inks.

70. The chemical UV indicator according to claim 66, wherein the substrate is formed of a material selected from the group consisting of skin, hair, fingernails, stone, wood, paper, plastic, laminate, resin, metal, shellac, fibers, leather, fabric, glass, polymers and combinations thereof.

71. The chemical UV indicator according to claim 66, wherein the indicator is coated on at least one surface thereof with one or more layers forming a laminate upon said substrate.

72. The chemical UV indicator according to claim 65, wherein at least one layer comprising said laminate is formed from a material selected from the group consisting of polyester/polyethylene, polypropylene and nylon.

73. The chemical UV indicator according to claim 71, wherein the laminate has a thickness of between about 1.2 and 10 mil.

74. The chemical UV indicator according to claim 66, wherein the substrate is provided with an adhesive backing to facilitate adherence of the chemical UV indicator to a surface.

75. A method of verifying exposure of a surface to sunlight, which method comprises providing the chemical UV indicator according to claim 66 on or at least adjacent said surface, in a path of sunlight during a term of exposure of said surface to said sunlight.

76. A method of verifying exposure of a surface to germicidal Ultraviolet C (UVC) radiation used to eradicate Methicillin-resistant Staphylococcus aureus and other microbial organisms, which method comprises providing the chemical UV indicator according to claim 66 on or at least adjacent said surface, in a path of said UVC radiation, during a term of exposure of said surface to said UVC radiation.

77. A method of verifying exposure of a surface to at least one of Ultraviolet A (UVA), Ultraviolet B (UVB) and Ultraviolet C (UVC radiation), which method comprises providing the chemical UV indicator of claim 66 on or at least adjacent said surface, in a path of the ultraviolet radiation, during a term of exposure of said surface to said ultraviolet radiation.

78. A method of verifying exposure of a surface to at least one of UVA and UVB radiation from a tanning lamp, which method comprises providing the chemical UV indicator according to claim 66 or at least adjacent said surface in a path of said UVA and/or UVB radiation during a term of exposure of said surface to said at least one of UVA and UVB radiation.

79. A method for curing a material selected from the group consisting or inks, paints and cosmetics by exposure to ultraviolet (UV) radiation wherein at least one of a degree and an amount of said radiation is determined by exposing the chemical UV indicator of claim 66 to said radiation.

80. A method for forming a chemical UV indicator, said method comprising:
applying to at least one surface of a substrate a formulation adapted for evaluating exposure to ultraviolet (UV) radiation, said formulation comprising
a) at least one material selected from the group consisting of tetrazolium compounds and formazan compounds, said compounds reacting in the presence of ultraviolet light, said reaction being evidenced by (i) an irreversible color change of said at least one material from a first color to a second color, said second color being one selected from the group consisting of a shade of said first color that is perceptibly darker than said first color, a shade of said first color that is perceptibly lighter than said first color; and a distinctly different color than said first color, or (ii) by an irreversible change from a colored state to a substantially colorless state or vice versa;
b) a polymeric binder that binds the formulation to a substrate;
c) a solvent that solubilizes solid components of said formulation; and
d) an additive comprising at least one of a proton donating compound and a compound that will undergo photolysis in the presence of ultraviolet light in order to generate free radicals, said additive stabilizing the color change of said at least one material by preventing reversion from said second color to said first color, or from the substantially colorless state back to the colored state.

81. The method according to claim 80, wherein the formulation is in a form selected from the group consisting of a liquid, an ink, a cream, an aerosol, a paint and a gel, and wherein the formulation is at least one of printed on a surface of the substrate and impregnated into the substrate.

82. The method according to claim 80, wherein the formulation is in the form of an ink and the substrate is printed with multiple inks.

83. The method according to claim 80, which further comprises forming the substrate from a material selected from the group consisting of skin, hair, fingernails, stone, wood, paper, plastic, laminate, resin, metal, shellac, fibers and combinations thereof.

84. The method according to claim 80, which further comprises coating the indicator on at least a portion of at least one surface thereof, with one or more layers to form a laminate upon the substrate.

85. The method according to claim 84, wherein the at least one layer comprising the laminate is formed from a material selected from the group consisting of polyester/polyethylene, polypropylene and nylon.

86. The method according to claim 84, wherein the laminate has a thickness of between about 1.2 and 10 mil.

87. The method according to claim 80, said method further comprising providing said substrate with an adhesive backing to facilitate adherence of said chemical UV indicator to a surface.

88. The method according to claim 80, wherein the tetrazolium compound comprises a tetrazolium salt having the general formula: 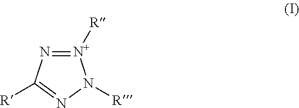
wherein each of R′, R″ and R′ are aromatic groups, which aromatic groups are all the same or different, and wherein the aromatic groups are substituted or unsubstituted.

89. The method according to claim 80, wherein the formazan compound comprises a formazan dye having the general formula: 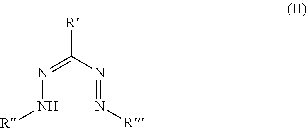
wherein each of R′, R″ and R′″ are aromatic groups, which aromatic groups are all the same or different, and the aromatic groups are substituted or unsubstituted.
